(19) United States
(12) Patent Application Publication
(10) Pub. No.: US 2008/0228629 A1
(43) Pub. Date: Sep. 18, 2008

(54) SYSTEM AND METHOD FOR VALUATING ITEMS AS TRADABLE ENVIRONMENTAL COMMODITIES

(76) Inventors: Philip Gotthelf, Closter, NJ (US); Nathan Guedalia, Fort Lee, NJ (US)

Correspondence Address: ADELI & TOLLEN, LLP, 1875 CENTURY PARK EAST, SUITE 1360, LOS ANGELES, CA, 90067, US

(21) Appl. No.: 12/047,290

(22) Filed: Mar. 12, 2008

Related U.S. Application Data
(60) Provisional application No. 60/894,380, filed on Mar. 12, 2007.

(51) Int. Cl. G06Q 40/00

(52) U.S. Cl. 705/37

(57) ABSTRACT

Some embodiments qualify an item and a protocol associated with the item by determining an amount of environmental conservation that is related to the actual use or implementation of the item by a registrant. Some embodiments quantify the environmental conservation of an item by determining an amount of emissions reduction, energy savings, hazardous wastes or materials that are properly disposed of, or generated renewable energy associated from the qualified environmental conservation of the item. Some embodiments then valuate the quantified environmental conservation to issue a tradable credit.

Some embodiments provide a protocol generation engine. The protocol generation engine of some embodiments automatically generates a new protocol for an environmental conservation item from the environmental conservation properties of the item. Some embodiments of the protocol generation engine provide an interface for the manual generation of a protocol.

### CLAIM OF BENEFIT TO PRIOR APPLICATION

This application claims benefit to U.S. Provisional Patent Application 60/894,380, filed Mar. 12, 2007. This U.S. Provisional Patent Application is incorporated herein by reference.

### FIELD OF THE INVENTION

The present invention relates to an environmental commodities exchange system and method. Specifically, to the qualification, quantification, and valuation of the environmental conservation associated with the use or application of an item.

### BACKGROUND OF THE INVENTION

Environmental regulations and stricter emissions controls are being advocated throughout various jurisdictions and countries in response to ever increasing concern over global warming. Global warming relates to the phenomenon in which an increase of carbon dioxide and other greenhouse gases within the Earth's atmosphere trap additional heat from the sun within the atmosphere causing climate change.

Several proposals have been set forth to curtail and reduce carbon and greenhouse emissions. One such proposal is set forth within the Kyoto Protocol, a 1997 international treaty that began taking effect in 2005. The Kyoto Protocol creates a commodities market in which allowances for emissions referred to as Carbon Credits, are purchased, sold, and traded.

Under the Kyoto Protocol, a central authority such as a governmental agency sets forth a limit for the amount of emissions that can be emitted by businesses and industries within the agency's jurisdiction. The stated goal to reduce emissions from the atmosphere involves creating incentives for and promoting emissions reducing business practices by providing a specified allotment of emissions allowances to these particular businesses and industries. Those businesses, industries, and even countries with efficient and environmental friendly operating practices can sell their unused allotment of Carbon Credits to other businesses, industries, and countries that have exceeded their allotment of emissions allowances. In this manner, heavy polluters can offset their excessive polluting activities by purchasing additional Carbon Credits or can improve their business practices to leave a smaller environmental footprint via more environmental friendly processes or manufacturing.

Some emissions reducing exchange models allow for the generation of new credits based on a set of standards that measure the emissions reductions provided by various products, projects, or technologies. Once the emissions reductions provided by such products, projects, or technologies reach a specified amount, a Carbon Credit is issued. The Acid Rain Program of the 1990 Clean Air Act in the United States is an example of a functioning emissions trading system for reducing sulfur dioxide (SOX) from the atmosphere.

There currently exist exchange systems for trading Carbon Credits (e.g., the Chicago Climate Exchange (CCX)). However, the functionality of these exchanges remains outside the reach of common consumers and small entities. In order to issue a tradable Carbon Credit within the CCX and other established exchanges, one must typically accumulate the equivalent of one metric ton of carbon emissions reduction or its equivalent. As a result, individual consumer purchases and small scale emissions reducing projects cannot become participants in the exchange. As such, these potential participants are dissuaded and in some instances restricted from participating in the emissions reducing market.

Therefore, there is a need for a comprehensive exchange system whereby participants of any size can participate. There is a need for the exchange system to reward participants of all qualities and quantities while still maintaining a widely-accepted definition for the trading commodity. Furthermore, there is a need for a scalable exchange system to accommodate various forms of environmental tradable commodities and credits. For example, in addition to creating credits for and providing a platform for emissions reductions, the exchange system should include: (1) tradable commodities that represent amounts of energy conservation associated with the use or application of newly developed products, projects, and technologies, (2) tradable commodities that represent amounts of properly disposed of or recycled hazardous materials and waste, (3) tradable commodities that represent quantifiable amounts of newly generated renewable energy. The exchange system should further scale to account for any new types of emissions, energy savings, hazardous waste and the associated products, projects, or technologies. The system should provide a level of convenience and automation thereby making the system accessible irrespective of the types of environmental tradable commodities, the sizes of the particular contributions by a user, and the knowledge of the users such that first time users are able conveniently participate in the system and are able to receive a benefit from their participation.

### SUMMARY OF THE INVENTION

Some embodiments of the invention provide various methods and systems for automatedly qualifying and quantifying an environmental conservation value for various environmental conservation items. In some embodiments, the quantified environmental conservation value is then valuated in order to issue a whole credit, a fractional credit, or equivalent compensable value for the fractional or whole credit to a registrant of the item.

Some embodiments qualify an item and the protocol associated with the item by determining an amount of environmental conservation that is related to the actual use or implementation of the item by a registrant. This manner of qualification computes a more unique environmental conservation for each item and registrant because the additionally accounted for qualification parameters bind the amount of environmental conservation resulting from the item to its actual use or application by the registrant. Accordingly, the environmental conservation associated with the same item and the same protocol often differs based on the specified actual usage parameters of the registrant.

Some embodiments quantify the environmental conservation of an item by determining an amount of emissions reduction, energy savings, hazardous wastes or materials that are properly disposed of, or generated renewable energy associated from the qualified environmental conservation of the item. The quantification provides a numerical environmental conservation value to quantify the amount of environmental conservation associated with the item. In some embodiments, the value represents an amount of emissions reduction, energy conservation, properly disposed of hazardous waste, or generated renewable energy. Some embodiments then valuate the quantified environmental conservation to issue a tradable credit, a fraction of a tradable credit, or to reimburse the registrant for the intrinsic value for the tradable credit or fraction of the tradable credit to be issued from the quantified environmental conservation.

Some embodiments select a protocol to perform the quantification and valuation from a variety of internal and external protocol sources. The external protocol sources include protocols used within other recognized exchanges, regulations of a given jurisdiction that govern protocol definition, or various utilities that define rebates based on various types energy usage or conservation. The internal protocol sources include protocols that are automatically or manually generated within some embodiments of the invention.

To facilitate internal protocol generation and the rapid adoption of the new items into the system, some embodiments provide a protocol generation engine. The protocol generation engine of some embodiments automatically generates a new protocol for an environmental conservation item from the environmental conservation properties of the item. Some embodiments of the protocol generation engine provide an interface for the manual generation of a protocol. In this manner, manufacturers of newly created environmental conservation items identify the environmental conservation properties of their items and define the protocols for quantifying the environmental conservation associated with the use or application of the item through the generated interface. The generated protocols are then validated to ensure compliance with the regulations of different jurisdictions or agencies. Once validated, some embodiments automatedly associate the protocol to an environmental conservation item such that subsequent registrations of the item by a consumer will automatically be associated with and valuated by the protocol.

### BRIEF DESCRIPTION OF THE DRAWINGS

FIG. 1 illustrates some embodiments of the valuation engine for automatedly identifying a protocol and one or more qualification parameters to use in qualifying, quantifying, and valuating the environmental conservation associated with a registered item.

FIG. 2 provides a more detailed illustration of the valuation engine of FIG. 1.

FIG. 3 illustrates new protocol generation functionality provided by some embodiments when an existing protocol cannot be located within the protocol database.

FIG. 4 presents a system architecture used by some embodiments to implement the registration, qualification, quantification, valuation, bundling, and trading functionality.

FIG. 5 conceptually illustrates the various sources from which some embodiments populate the protocol database with protocols.

FIG. 6 conceptually illustrates the automated protocol identification performed by some embodiments based on one or more properties of an item.

FIG. 7 presents an illustration of the protocol database in which a first item with associated environmental conservation properties purchased in one region can potentially be valued by one set of protocols and a second item with associated environmental conservation properties purchased in a second region can potentially be valued by a second set of protocols.

FIG. 8 presents a protocol generation process performed by the protocol generation module of the valuation engine that conceptually illustrates several operations performed by the protocol generation module of the valuation engine to generate a new protocol for an item.

FIG. 9 illustrates a graphical interface through which manufacturers define and enter certain parameters to uniquely identify each of their environmental conservation items from other environmental conservation items registered within the system.

FIG. 10 presents a screen definition provided to a manufacturer to further define a registration screen for subsequent consumers of an item in accordance with some embodiments of the invention.

FIG. 11 presents a graphical interface for defining qualification parameters related to the actual use of an item by a registrant.

FIG. 12 presents a protocol definition graphical interface for manually defining a protocol for a new environmental conservation item.

FIG. 13 presents an automated protocol generation process performed by the protocol generation module of the valuation engine that conceptually illustrates several operations performed by the protocol generation module to automatically generate a new protocol for an item.

FIG. 14, provides a computer implemented and automated method for submitting newly generated protocols to a protocol approving entity in accordance with some embodiments.

FIG. 15 presents a process that conceptually illustrates several operations performed for facilitating the automated submission of protocols for validation.

FIG. 16 presents various qualification parameters associated with the electrical usage of an environmental conservation item.

FIG. 17 conceptually illustrates a simplified method of some embodiments for computing an environmental conservation value of an environmental conservation item when considering qualification parameters.

FIG. 18 presents a process performed by the quantification module of the valuation engine for quantifying the environmental conservation associated with an item in order to produce the environmental conservation value.

FIG. 19 presents a process performed by the valuation module of the valuation engine for performing the valuation of a quantified environmental conservation value in order to issue credits and to provide compensation for the contribution towards the issuance of the credits.

FIG. 20 presents an illustrative interface of some embodiments whereby a balance of all items registered by a particular registrant is tracked.

FIG. 21 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

I. Overview

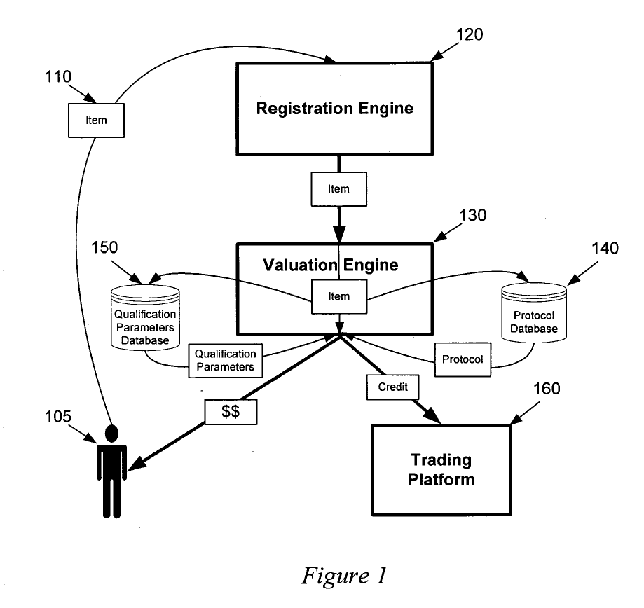

Some embodiments provide a valuation engine for qualifying, quantifying, and valuating the environmental conservation associated with one or more environmental conservation items in order to issue tradable environmental credits (i.e., commodities), fractional credits, or compensable sums corresponding to the value of the credit or fraction of the credit to issue. FIG. 1 illustrates some embodiments of the valuation engine for automatedly identifying a protocol and one or more qualification parameters to use in qualifying, quantifying, and valuating the environmental conservation associated with a registered item.

In this figure, a user 105 registers an environmental conservation item 110 through an interface provided by the registration engine 120. The user 105 registers the item 110 by specifying a minimal set of identification parameters related to the item 110 using the provided interface. From the identification parameters, the valuation engine 130 identifies the proper protocols from the protocol database 140 and the proper qualification parameters for qualifying, quantify, and valuating the environmental conservation in order to issue a credit to the trading platform 160 and/or the monetary equivalent to the registrant 105.

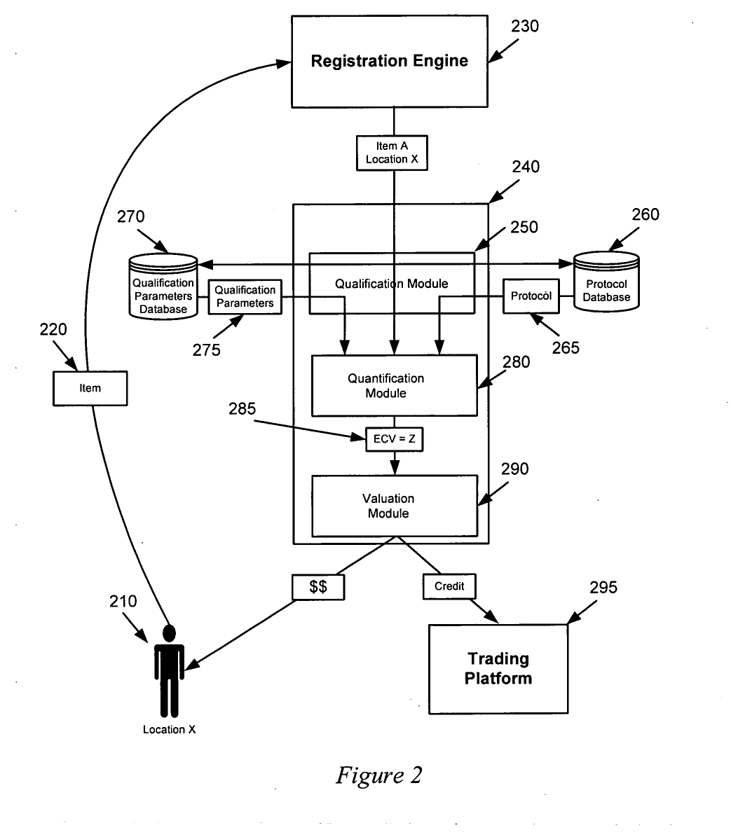

FIG. 2 provides a more detailed illustration of the valuation engine 130 of FIG. 1. Specifically, the registration engine 230 passes the registration information 220 received from the user 210 using a registration interface to the qualification module 250 of the valuation engine 240. The qualification module 250 automatedly attempts to identify a protocol 265 for computing the environmental conservation associated with the item 220 from the protocol database 260. In some embodiments, identification of the protocol 265 is based on a set of identification parameters specified for the registered item 220, such as a stock keeping unit (SKU), serial number, universal product code (UPC), vehicle identification number (VIN), or make and model of the item as some examples. In other embodiments, identification of the protocol 265 is based on a set of environmental conservation properties of the item 220, such as the amount of electricity consumed per hour of use, miles per gallon (MPG), or generated renewable energy per hour of operation as some examples. To perform the automated protocol identification, some embodiments maintain a protocol database 260 that stores a pool of protocols where one or more protocols may be associated with each registered item.

The qualification module 250 also retrieves a set of qualification parameters 275 from the qualification database 270. The qualification parameters 275 specify parameters that are linked to the actual usage or application of the item. For instance, in computing the emissions reduction resulting from the transition between an incandescent light bulb and a compact fluorescent light bulb, some embodiments compute the emissions reduction by accounting for the emissions produced from the actual power plant providing the electricity to the registrant. Therefore, a compact fluorescent bulb registered by a user receiving power from a coal burning power producing facility will result in a first amount of carbon dioxide (CO2) reductions when compared to the same compact fluorescent bulb being registered by a second user receiving power from a hydroelectric power producing facility. Such qualification is performed by acquiring the address information of the registrant and retrieving the electricity generation parameters associated with the address from the qualification parameters database 270. Other qualification parameters associated with energy consumption include an amount of line loss resulting from the transmission of the electricity from the power producing facility to the address where the item is used.

The item information 220, protocol 265, and one or more qualification parameters 275 are then passed to the quantification module 280 of the valuation engine 240. The quantification module 280 computes an environmental conservation value 285 for the item based on the received data. The environmental conservation value is a numerical value that represents a quantified amount of environmental conservation. In some instances, the value represents an amount of emissions reduction, energy conservation, properly disposed of hazardous waste, or generated renewable energy. Definitions for these and various other terms are provided in Section II below.

The valuation module 290 receives the environmental conservation value. From the environmental conservation value, the valuation module 290 issues a tradable commodity such as a credit for placement within the trading platform 295 of some embodiments or trading platforms of other environmental commodities exchanges. In some embodiments, the valuation module 290 issues a fractional credit that is subsequently bundled with other fractionally issued credits in order to attain a standard or pre-defined amount of emissions reduction, energy savings, hazardous waste reduction, or renewable energy required for issuing a new credit within the various trading platforms. Since the issued credit or fractional credit contains an intrinsic value based on its current or future trading value, some embodiments of the valuation module 290 compensate the registrant 210 by distributing a compensable sum derived from the monetary value of the issued credit to the registrant 210.

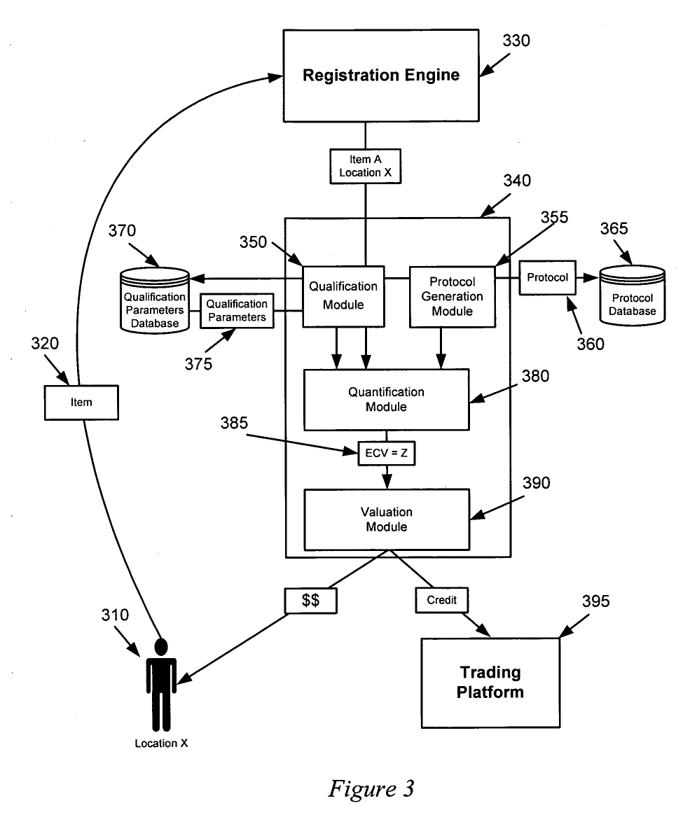

FIG. 3 illustrates new protocol generation functionality provided by some embodiments when an existing protocol cannot be located within the protocol database. In some embodiments, the protocol generation module 355 permit users the ability to manually specify one or more new protocols 360 to associate with the item 320. In such instances, the protocol generation module 355 generates a graphical interface that is presented to the user through the registration engine 330. The graphical interface allows the user the ability to specify the parameters, variables, and formulas of the protocol.

In some embodiments, the protocol generation module 355 allows for the automated generation of a new protocol without user action. In some such embodiments, an automated process determines and generates a new protocol 360 based on the identified environmental conservation properties of the item 320 during registration. Some embodiments further base the formulas or heuristics for the newly generated protocol 360 on, but not limited to, internationally agreed treaties, international and national standards, market factors, formulas approved by some regulatory body, or formulas voluntary approved for a pact between multiple entities participating in the environmental commodities exchange.

Some embodiments of the protocol generation module 355 perform validation to ensure that the generated protocol complies with predefined standards and accurately computes the environmental conservation associated with the item. If a newly generated protocol 360 is determined to be valid, then the protocol 360 is stored within the protocol database 365 and the protocol 360 is passed to the quantification module 380. By storing the protocol 360 within the protocol database 365, the protocol 360 is made available for subsequent registrations of the same or similar items. In this manner, the protocol database 365 is an adaptive growing database that is able to adjust automatically to new environmental conservation items as they are introduced into the marketplace or as they are actually used by one or more users.

Several more detailed embodiments of the invention are described in the sections below. Before describing these embodiments further, definitions for the terms and concepts used by some embodiments of the invention are given in Section II below. This discussion is followed by the discussion in Section III of an overview of a system architecture used by some embodiments to implement the registration, qualification, quantification, valuation, bundling, and trading functionality. Section IV describes various implementations for valuation functionality. Specifically, various implementations for qualifying, quantifying, and valuating the environmental conservation associated with an environmental conservation item. Last, Section V describes a computer system which implements some of the embodiments of the invention.

II. Definitions

In some embodiments, the credits are tradable environmental commodities that represent various kinds or amounts of emissions. In some embodiments, the emissions include various greenhouse gases and environmental pollutants, such as carbon dioxide, ozone, methane, nitrous oxide, sulfur dioxide, hydrofluorocarbons, perfluorocarbons, sulfur hexafluoride, various refrigerants, and other effluents into the environment. Such emissions include atmospheric and non-atmospheric emissions.

Additionally, the credits of some embodiments represent more generalized forms of energy savings, energy conservation, hazardous waste reduction, or renewable energy. For instance, credits representing reductions in the usage of energy include reductions in the usage of kilowatt hours, gas British thermal units (“BTU's”), propane, and coal as some examples. It will be apparent to one of ordinary skill in the art that various other reductions in the usage of energy are similarly covered within the scope of the invention.

In some embodiments, credits that represent some quantifiable reduction in the amount of hazardous waste or materials are provided a compensable value in the form of a municipality issued rebate or utility approved rebate when an item containing hazardous waste or materials is properly disposed of. This value is determined through the quantity and quality of the hazardous material or waste within the item. For instance, a small amount of highly radioactive material that is properly disposed of may result in a similar value as a large amount of mercury that is properly disposed of, where a proportional amount of mercury is relatively less toxic than that of the highly radioactive material.

In this manner, an incentive is created to remove such hazardous waste or materials from traditional landfills, where such toxins can contaminate the soil or seep into the water supply. For instance, the proper disposal of light bulbs or computer components containing mercury or lead, batteries containing toxic metals such as alkaline, lithium, and nickel-cadmium, and light ballasts containing polychlorinated biphenyls (PCBs) removes these toxic materials from landfills and instead moves the toxic materials to a facility where they can be properly and safely disposed of or even recycled. Moreover, the administration and oversight regarding the rebates is removed from the municipality or utility and is instead given to some embodiments where it is readily facilitated through a computer implemented interface.

It will be apparent to one of ordinary skill in the art that various other solids, liquids, contained gases, or sludges that are a result of by-products from manufacturing processes or discarded products that potentially can contaminate the soil, water supply, or cause other environmental harm are similarly covered within the scope of the invention. The Environmental Protection Agency (EPA) has issued certain lists (e.g., F-list for non-specific source wastes, K-list for source-specific wastes, P-list and U-list for discarded commercial chemical products) to cover certain recognized wastes with certain ignitable, corrosive, reactive, or toxic properties that would be applicable to some embodiments of the invention.

In some embodiments, the credits also represent standard or pre-defined amounts of generated renewable energy. Such renewable energy includes energy created from wind farms or solar farms as some examples, though renewable energy may be derived from other renewable sources such as geothermal heat, biomass, landfill waste, or by-products of farming operations.

The generated renewable energy can be sold back into the electric grid, but can also be used to determine some quantifiable amount of emissions reduction. Since, the generated renewable energy was created without producing atmospheric emissions, there is a quantifiable amount of emissions reductions attributable to the amount of generated renewable energy. Specifically, every unit of renewable energy that is created and sold back into the electric grid results in one fewer unit of energy that has to be created from traditional polluting means.

The credits of some embodiments may also take the form of rebates that are issued by municipalities or various other regulatory agencies for meeting certain criteria in environmental conservation. Such environmental conservation includes receiving rebates for the purchase and installation of a water heater with energy ratings that fall within a specified threshold or for the proper disposal of items containing hazardous materials that could otherwise harm the environment if placed within a landfill.

In some embodiments, the environmental conservation items include various products, projects, and technologies that quantifiably impact the environment to result in a measurable about of environmental conservation. In some embodiments, an environmental conservation product is a product with some less efficient or less environmentally friendly pre-existing analog. Since efficient environmental conservation products consume less energy, less energy needs to be produced. Power plants that generate the energy consumed by the products produce a certain amount of greenhouse gases with every unit of generated energy and consumed energy. Therefore, the equivalent use of a more efficient product compared to a less efficient analog product requires less energy to be produced resulting in fewer greenhouse emissions from the power plant. For instance, hybrid vehicles as opposed to traditional combustion engine vehicles consume less gasoline per mile driven. Since the combustion process for converting gasoline into energy is mainly responsible for the carbon dioxide emissions associated with automobiles, combusting less gasoline results in less carbon dioxide being released into the atmosphere. Similarly energy efficient lighting, such as compact fluorescent light bulbs as opposed to less energy efficient incandescent light bulbs, consume less electricity over their respective lifetimes to produce an equivalent amount of light. Since a unit of electricity that is consumed is typically derived from some polluting power generating process (e.g., natural gas power plants, coal fueled power plants), the fewer units of electricity consumed, the fewer the amount of pollutants produced.

Environmental conservation projects include processes such as carbon sequestering that remove or reduce atmospheric greenhouse emissions. Additionally, some projects may generate energy thereby reducing the amount of pollution associated with other power generating activities. In some embodiments, the environmental conservation associated with a project contains some overlap with products. For example, a lighting retrofit project involves replacing older inefficient light bulbs for an entire building or enterprise with newer efficient light bulbs. Such a project provides a level of environmental conservation by virtue of the products used within the product. As such, the environmental conservation associated with these projects and products may be registered only once.

Similarly, a newly developed technology without any previously existing analog that reduces energy usage, emissions, or cleanly produces energy over traditional means would have a set of associated environmental conservation properties that could be used to quantifiably compute the environmental conservation associated with the item. An example of such a technology would be a viable commercial implementation of cold fusion.

The quantifiable impact of such items is determined through the various environmental conservation properties of the items that include attributes or characteristics of the item that identify an amount of emissions reductions, energy conservation, reduction in hazardous materials/waste, or generated renewable energy associated with the use or application of the item. From the set of properties, an environmental conservation value is determined and associated with the item. In some embodiments, the environmental conservation value represents a numerical quantification of the amount of environmental conservation that results from the item over its useful life. Specifically, a typical quantifiable metric in defining the environmental conservation value for an item is to measure the amount of carbon dioxide (CO2) emissions associated with a particular item over its useful life.

The environmental conservation values are computed using one or more protocols. Protocols compute the environmental conservation values over an item's set of environmental conservation properties. Additionally, some embodiments compute the environmental conservation values based on an actual use or implementation of the device through various qualification parameters. The qualification parameters relate the actual amount of environmental conservation produced by an item to a user's usage behavior and actual energy used by the item. Different protocols may be applied to the same item to derive different environmental conservation values depending on differing regulations, jurisdictions, credit exchanges, etc. Accordingly, one or more protocols can be applied to compute the environmental conservation values of the same item. The protocols used in quantifying and valuating the environmental conservation of an item are derived from a variety of sources including international treaties, municipalities, states, federal governments, quasi-governmental regulatory bodies formed to oversee environmental regulations, or voluntary pacts between participants in the environmental commodities exchange.

When a standard or pre-defined amount of the environmental conservation value is met, either through the environmental conservation value of a single item or through multiple items, some embodiments issue a tradable environmental commodity, such as a Carbon Credit. The commodities can then be bought, sold, and traded within various environmental commodities exchanges (i.e., wholesale market) or sold to the public by means of a retail shopping cart (i.e., retail market).

The value of these issued credits stems from the ability to use the credits to offset certain amounts of pollution resulting from the credit owner's activities, whether manufacturing, transporting, or developing and the offsetting of such activities is recognized within some enforceable regulation. For instance, the Kyoto treaty created caps or quotas for the amount of carbon emissions that various countries can emit. Therefore, when a country exceeds its quota, the country is required to purchase credits to offset the extra amount of pollution generated in excess of the allotted quota. Moreover, some regulations require local utilities to either reduce their emissions production and energy consumption or use green power for a certain percentage of their business related activities. Therefore, some utilities unable to generate the green energy may simply purchase credits that represent certain amounts of generated green energy from others. Other reductions might be voluntary or contractual, based upon a corporate policy or mandate, and subject to legal enforcement. Once such example is found in the membership requirements on the Chicago Climate Exchange that requires members to adhere to scheduled emissions reductions.

Several protocol formulas for computing the environmental conservation value for various environmental conservation items will now be provided. A C.A.F.E. (Corporate Average Fleet/Fuel Economy) protocol may be used by some embodiments to compute the environmental conservation value associated with a vehicle. The formula specifies vehicle fuel savings as the difference between the mileage of the vehicle and the C.A.F.E. value. The computed fuel savings value is then converted into an environmental conservation value (ECV) using a second formula in which:

ECV=Average Annual Mileage of the Vehicle−(Fuel Savings/Product Mileage*C.A.F.E)*Lbs. of CO2

Some embodiments provide a protocol for determining the environmental conservation value of light bulbs. The protocol converts the emissions savings of an energy efficient light bulb into an environmental conservation value using the following formula:

ECV=(Wattage Equivalence for the Energy Saving Bulb−Actual Wattage)*(Hours per Year)*Lbs of Carbon per Watt associated with a specific power generating facility (utility).

The above examples illustrate the computation of an environmental conservation value using the amount of CO2 reductions as the measurable metric. Emissions of other non-CO2 greenhouse gases can similarly be converted to metric tons of CO2 in order to calculate an environmental conservation value associated with a registered item. A recognized method is to use a CO2 equivalent such as the one hundred year Global Warming Potential (GWP) value as established by the Intergovernmental Panel on Climate Change. The GWP is based on various factors such as a particular heat-absorbing ability of a particular emitting gas also referred to as the radioactive efficiency of the gas. Therefore, protocols of some embodiments can be adapted for computing emissions reductions of credits involving non-CO2 greenhouse gases.

Moreover, it should be apparent to one of ordinary skill in the art that the protocols of some embodiments use various other measurable metrics in computing the environmental conservation value (e.g., kilowatt hours generated from a renewable energy source). It should also be apparent to one of ordinary skill in the art that the protocols of some embodiments can be adapted for computing other emissions reductions, energy savings, reductions in hazardous wastes or materials, and for valuing amounts of generated renewable energy. For example, in order to track and create a rebate for reductions in the hazardous materials of light bulbs such as mercury, some embodiments compute the environmental conservation value associated with the reduction in mercury using the following equation:

$$Mercury Content [ Picograms \text{/} Lumen Hours ] = [ {\sum }_{TypesofBulbs} ( Total mercury content per bulb type ) ] / [ {\sum }_{TypesofBulbs} ( Total lumen hours ) ] * 10 ** 12$$

III. Architecture

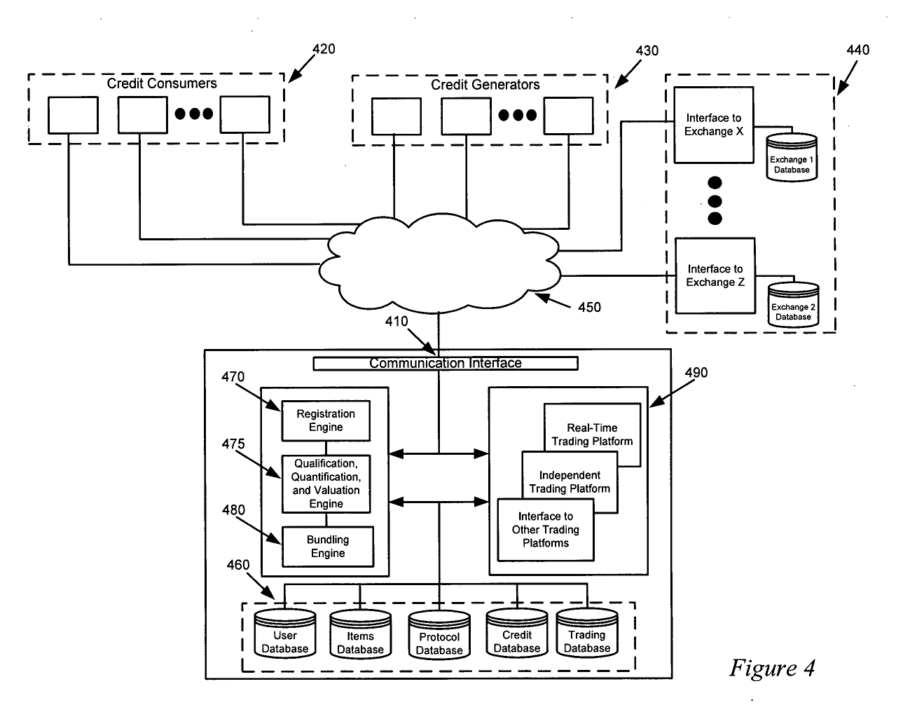

FIG. 4 presents a system architecture used by some embodiments to implement the registration, qualification, quantification, valuation, bundling, and trading functionality. As illustrated in FIG. 4, communications with the system are facilitated through a computer implemented interface 410 in which credit consumers 420, credit generators 430, and other exchanges 440 access the system through a communication medium 450. In some embodiments, the credit consumers 420 and the credit generators 430 include registrants of the environmental conservation items and the buyers and sellers participating within the trading platform. In some embodiments, the credit consumers 420 and credit generators 430 include individual consumers, groups of consumers, businesses, governmental agencies, environmental groups, and other exchanges engaged in environmental commodities trading.

In some embodiments, the communication medium 450 is any network or network of networks through which different devices access the various functionalities provided by the various engines and sub-modules of the engines described below. The communication interfaces for the communication medium 450 include the internet, plain old telephone system (POTS), wireless data services (GPRS), local area network (LAN), wide area network (WAN), or other physical or wireless communication medium. In some embodiments the communication interface 410 is implemented to provide web server functionality via some or all such interfaces. Additionally, the communication interface 410 of some embodiments is implemented using a Service Oriented Architecture (SOA). Using the SOA, some embodiments are capable of processing incoming information through two or more integrated interfaces. These interfaces include other applications, websites, or user interfaces. Additionally, in some embodiments, the various engines (e.g., registration engine, valuation engine, bundling engine, trading engine, or their respective modules) create the interfaces provided to users over the communication interface 410.

In this manner, the architecture of FIG. 4 permits credit consumers 420, credit generators 430, and the other exchanges 440 to be located anywhere throughout the world while still permitting such entities access to the services provided by the system using a variety of different communication devices such as personal digital assistants (PDAs), computers, wireless smartphones, or any internet enabled device. Accordingly, the system interface unifies all entities so that a single entity accessing the system can interact with all other entities accessing the system through a single interface regardless of its physical location throughout the world. For instance, if the entity was a credit generator, then the entity would interact with other credit generators by bundling his items with those of other credit generators.

Some embodiments of the invention store information related to registering, qualifying, quantifying, valuating, bundling, and trading in a set of databases 460. These databases 460 store information such as the available items ready for bundling, the environmental conservation properties of the items, the qualification parameters of the items, the environmental conservation values associated with the items, issued credits, the useful life of the credits, protocols used to value the environmental conservation values of the items, or general user access information as some examples. One of ordinary skill in the art will recognize that some embodiments of the invention include some, all, or additional databases 460 for storing information pertaining to the functionality provided by the system. Additionally, though the databases 460 have been shown as multiple databases, one of ordinary skill in the art will recognize that the multiple representations can be a conceptual representation and that the actual physical implementation may be conducted through a single database. The system also includes logic for querying, storing, and retrieving information from such storage locations 460 and for presenting the information through the interface 410 to the users.

Functionality within the system is provided via the various functional engines. In FIG. 4, the system includes a registration engine 470, a qualification, quantification, and valuation engine 475, a bundling engine 480, and a trading engine 490. In some embodiments, one or more of the engines represents software processes executed by a processor of a computing device. In other embodiments, one or more of the engines represents physical hardware devices that implement the functionality described herein. It should be apparent to one of ordinary skill in the art that the various other functional modules may similarly be incorporated within the overall system.

The registration engine 470 implements the interface through which environmental conservation items are registered and administrative functionality pertaining to the management of a user account is performed (e.g., disbursing of payments and tracking of registered items). The functionality for the registration engine 470 is described in further detail in the U.S. patent application titled “Registration Method and System for an Environmental Commodities Exchange” with attorney docket EQDX.P0015 which is incorporated herein by reference. An overview of the valuation engine 475 was provided above with respect to FIGS. 1-3, however a more detailed description of the valuation engine will be provided in Section IV below. The bundling engine 480 provides the bundling and unbundling of fractional credits, buyers, and sellers. The functionality for the bundling engine 490 is described in further detail in the U.S. patent application titled “A Bundling Method and System For Credits of an Environmental Commodities Exchange” with attorney docket EQDX.P0010 which is also incorporated herein by reference. The trading engine 490 provides the trading platform over which credits are bought, sold, and traded. The functionality for the trading engine 490 is described in further detail in the U.S. patent application titled “Registration Method and System for an Environmental Commodities Exchange” with attorney docket EQDX.P0015.

IV. Valuation

A. Protocol Identification

As described above, a set of protocols are used to compute the environmental conservation values for the registered items. The protocols define the processes or heuristics that determine the quantifiable amount of environmental conservation for an item in the form of the environmental conservation value. However, because different items contain different environmental conservation properties and different protocols specify different variables and parameters to determine the environmental conservation value of an item, some embodiments of the valuation engine must first select the proper protocol for the item before being able to compute the environmental conservation value of the item.

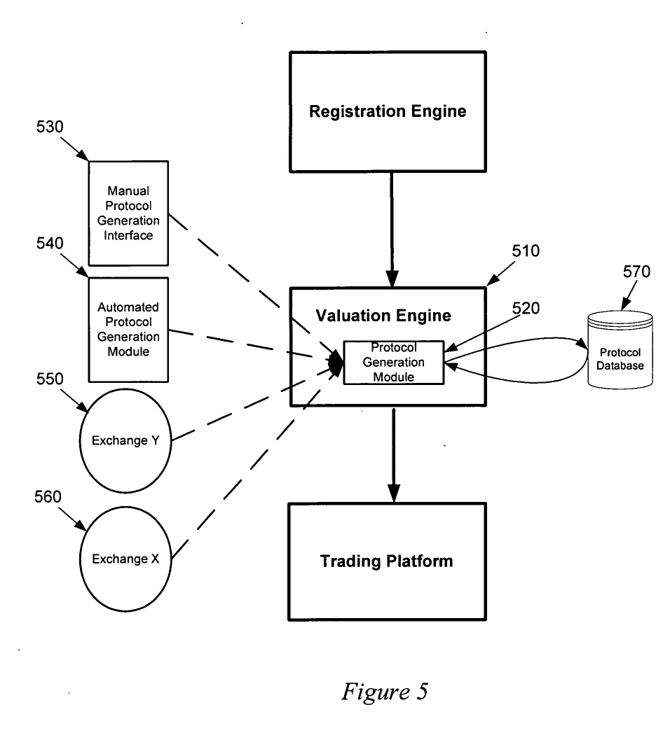

In some embodiments, one or more protocol databases store and maintain a set of protocols that are usable to quantify and valuate the environmental conservation values for a set of corresponding items. FIG. 5 conceptually illustrates the various sources from which some embodiments populate the protocol database with protocols. In this figure, the protocol generation module 520 of the valuation engine 510 compiles the set of protocols within the protocol database 570 from a manual protocol generation interface 530, an automated protocol generation module 540, and the protocol databases of other environmental commodities exchanges of which only two, 550 and 560, are shown for the sake of simplicity.

The manual protocol generation interface 530 provides a manual user interface through which users specify custom protocols for newly manufactured items that do not contain preexisting protocols within the protocol database 570. The automated protocol generation module 540 automatedly generates protocols for items that do not contain preexisting corresponding protocols within the protocol database 570. Both the manual protocol generation interface 530 and the automated protocol generation module 540 are described in further detail in subsection B below.

Additionally, by interfacing with the protocol databases of the other exchanges 550 and 560, some embodiments are able to leverage and adopt the proprietary sets of protocols of the exchanges 550 and 560 in order to issue credit for trading within the trading platforms of the other exchanges 550 and 560. The interface with the protocol databases of the exchanges 550 and 560 is facilitated by an electronic communication interface that provides direct access to the protocol databases of the other exchanges. In this manner, some embodiments can update in real-time the protocol database 570 with the protocols of the other exchanges 550 and 560, even though each such exchange may manually specify the protocols to be included within the proprietary databases. The electronic communication interface of some embodiments is facilitated via a standard IP network or through other communication networks such as a wireless packet data network (i.e., GPRS).

Since some exchanges operate exclusively within a particular jurisdiction (e.g., a European environmental commodities exchange or a North American environmental commodities exchange), some embodiments store the retrieved protocols within the protocol database 570 by including a parameter to specify the jurisdictions and permit use of the appropriate protocol when quantifying the environmental conservation relative to a particular jurisdiction. It should be apparent to one of ordinary skill in the art that any level of jurisdictional granularity can be used to store the protocols. For instance, some embodiments store protocols based on the one or more postal zipcodes for which they can be used. Therefore, a registrant who registers an energy efficient light bulb while residing in zipcode X may be assigned a first protocol from which to determine the environmental conservation value of the light bulb. A different registrant who registers the same energy efficient light bulb while residing in zipcode Y may be assigned a second protocol from which to determine the environmental conservation value of the light bulb.

The unified protocols within the protocol database 570 also allows users the ability to leverage the trading platforms of the other exchanges 550 and 560 irrespective of jurisdictional concerns. In this manner, protocols may be used to define credits for trading within the European Climate Exchange (ECX) or the CCX. This creates a larger pool of participants by introducing non-member participants into the exchanges.

The system automates the selection of an appropriate protocol from the pool of protocols stored within the database 570 in order to remove the overhead of identifying the appropriate protocol from the user registering an environmental conservation item. Often registrants do not know enough about the product they are registering to select the appropriate protocol. Registrants are similarly unaware of the formulas and variables used to derive the protocols and because multiple protocols may be associated with a single item, the registrant may become confused when faced with selecting a particular protocol from a pool of protocols. By removing this level of confusion, some embodiments simplify and therefore encourage the participation of registrants that would otherwise be dissuaded by the complexities of such a system.

Such an automated system of protocol identification also assists manufacturers from the complexities of protocol definition. For example, some embodiments permit some or all the protocols to be extended to quantify and valuate the environmental conservation of items for which they were not originally associated with. Specifically, manufacturer X produces energy efficient light bulbs with a luminance property A, wattage consumption property B, and material composition C. Manufacturer X specifies a protocol Z to compute the environmental conservation value of the energy efficient light bulb. Manufacturer Y then registers an energy efficient light bulb with a luminance property A, wattage consumption property B, and material composition D, however manufacturer Y omits specifying a protocol for the item. As the light bulbs from manufacturers X and Y contain the same luminance property A and wattage consumption property B, some embodiments of the invention automatically associate and apply the protocol Z to compute the environmental conservation value of the manufacturer Y light bulb, even though the material compositions of the bulbs are different.

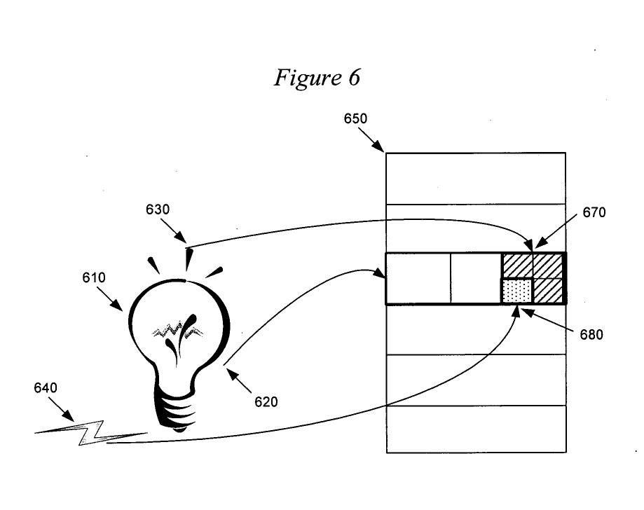

FIG. 6 conceptually illustrates the automated protocol identification performed by some embodiments based on one or more properties of an item. In this figure, a registrant registers an energy efficient light bulb 610 by specifying various properties of the item through an item registration interface provided by a registration engine of some embodiments. These properties may include nothing more than basic identification parameters such as a make and model of the particular light bulb 610 to be registered. For some items, a single parameter of the item is sufficient to uniquely identify the item. Such is the case with a vehicle identification number (VIN) where the VIN uniquely identifies the vehicle.

From the first set of parameters, some embodiments contain sufficient information regarding the environmental conservation properties for the item. Alternatively, some embodiments search based on the first set of parameters to identify additional environmental conservation properties for the item. This removes the need for the registrant to have a working knowledge or understanding of the properties of the item. Specifically, in the case of the energy efficient light bulb 610, some embodiments identify the properties 620-640 that specify the luminance, wattage, and material composition of the light bulb 610 based on one or more identification parameters.

Some embodiments attempt to locate a directly matching protocol for the item by deriving a direct index parameter into the protocol database using only the identification information of the item. However, if the protocol cannot be located in this manner, then some embodiments attempt to locate the protocol using the environmental conservation properties of the item. It should be apparent to one of ordinary skill in the art that in some embodiments, the environmental conservation properties 620-640 include more or less properties than those enumerated above. Each environmental conservation property of the item 610 is used to locate a protocol within the protocol database 650. Property 620 identifies that the registered item is a light bulb. Using this property 620, the search identifies a set of records 660 within the protocol database that identify protocols that are usable in computing the environmental conservation value of an energy efficient light bulb. To further narrow the search and restrict the identified set of protocol with which to associate to the light bulb 610, a second property of the light bulb 610 is used as a parameter to query the protocol database. In FIG. 6, property 630 is used to further narrow the identified set of protocols to a set of records 670 within the protocol database 650. In FIG. 6, property 630 specifies a luminance of the light bulb.

In some embodiments, a third property is required to determine an exact protocol to associate to the item 610. Therefore, property 640, which specifies the wattage consumed by the light bulb 610, is used to narrow the search and identify protocol 680 as a suitable protocol from which to compute the environmental conservation value of the light bulb 610. One of ordinary skill in the art will recognize that some items or different variations of the same item contain more or less properties with which to identify and retrieve a protocol from the protocol database 650. In some embodiments, a protocol can be located within the protocol database by using only some of the environmental conservation properties of the item. Additionally, some embodiments use different combinations of the set of properties to identify the same or different protocol.

In some embodiments, multiple items can utilize the same protocol. Therefore, protocols need not have a one-to-one association with an environmental conservation item. Rather, protocols may have a one-to-many association and conversely, a many-to-one association in which several protocols may be applied to value the same item. An example of the later includes, a registered item that has a first protocol that derives an environmental conservation value in the form of properly disposed of hazardous materials and a second protocol that derives an environmental conservation value in the form of generated renewable energy. Specifically, a tire that is composed of toxic materials contains two compensable forms of environmental conservation. Firstly, when the tire is properly disposed of as opposed to being placed in a landfill, a first environmental conservation value can be computed for the proper disposal of the non-biodegradable properties of the tire. Secondly, if the same tire is then processed to produce some amount of fuel, a second environmental conservation value can be computed for the fuel derived from the tire.

Protocols may also have a many-to-one relationship when an item has different protocols to compute the environmental conservation value of the item in different jurisdictions. Each protocol may be valid at an international, federal, state, or municipal level. Moreover, some embodiments set forth protocols based on socially accepted standards or standards accepted by various consortiums operating independent of any governmental entity which may include voluntary pacts between two or more entities.

Multiple sets of protocols can also be associated with a single item in some embodiments by using protocols existing within and outside the scope of the system. For instance, recognized exchanges, such as the CCX, contain proprietary sets of protocols for defining the emissions reductions associated with products and projects being traded within its exchange. However, some embodiments of the invention may also include their own set of protocols that either follow or establish independent sets of standards for measuring emissions.

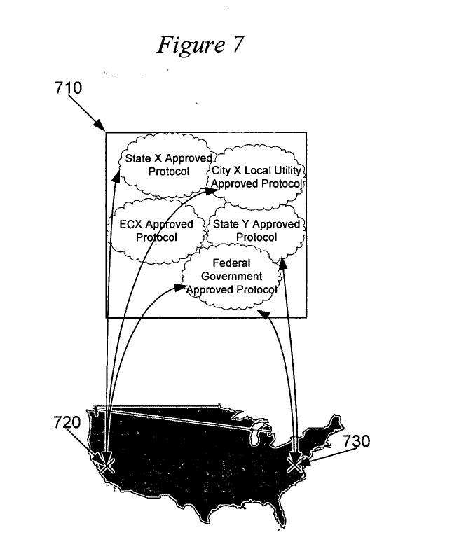

FIG. 7 presents an illustration of the protocol database 710 in which a first item with associated environmental conservation properties purchased in one region 720 can potentially be valued by one set of protocols and a second item with associated environmental conservation properties purchased in a second region 730 can potentially be valued by a second set of protocols. In FIG. 7, the first and second set of protocols share at least one protocol from the protocol database. Specifically, the item 720 includes three associated protocols for valuation: a federal, state, and local municipal protocol. In some embodiments, these protocols are based on different national, state, and local standards which produce different sets of regulations for deriving the formulas or heuristics for computing the environmental conservation values of the registered item. As federal regulations apply regardless of the state citizenship of the registrant, the federal approved protocol is applicable to both items 720 and 730. However, item 730 cannot use 720's state protocol and therefore a different state approved protocol is stored within the database 710 for determining the environmental conservation of item 730 per the corresponding state's requirements.

B. Protocol Generation

In instances where a protocol does not exist and a protocol for a similar item cannot be identified, some embodiments allow for the generation of new protocols. This allows some embodiments to facilitate the rapid adoption of new environmental conservation items (e.g., products, projects, and technologies) into the environmental commodities exchange. In some embodiments, a protocol generation module automatically creates and generates a protocol for any new environmental conservation item that does not contain a pre-existing protocol. Additionally, some embodiments of the protocol generation module permit registrants, manufacturers, other non-consumers, or a system administrator the ability to propose new protocols over a computer implemented interface.

While the recognized exchanges (e.g., CCX) permit its members to propose new protocols, such an approval process requires the member to be familiar with protocol formulation and the various algorithms and standards that are typically used in such protocols and the regulations set forth by the various jurisdictions in which the protocol is intended for use. Furthermore, in order to propose the protocol to the recognized exchanges, the member must be registered with each exchange that he intends to submit the protocol and the applicant is required to propose the protocol to each desired exchange separately.

By providing an automated protocol generation module, some embodiments of the invention remove such implementation complexity from the users. In this manner, users including ordinary consumers of commercial products need not have any working knowledge of the purchased item to receive a benefit and to participate in the environmental commodities exchange. Should a user desire to manually define the protocol, such functionality is available without the described limitations of the other exchanges. For instance, after manually defining the protocol, the registrant specifies a list of entities to approve the protocol. Some embodiments submit the protocol on behalf of the user to all such entities at one time rather than separate submissions. Moreover, because the submission is conducted on behalf of the user, the approval process occurs automatically and transparently irrespective of whether the user is a member of each exchange.

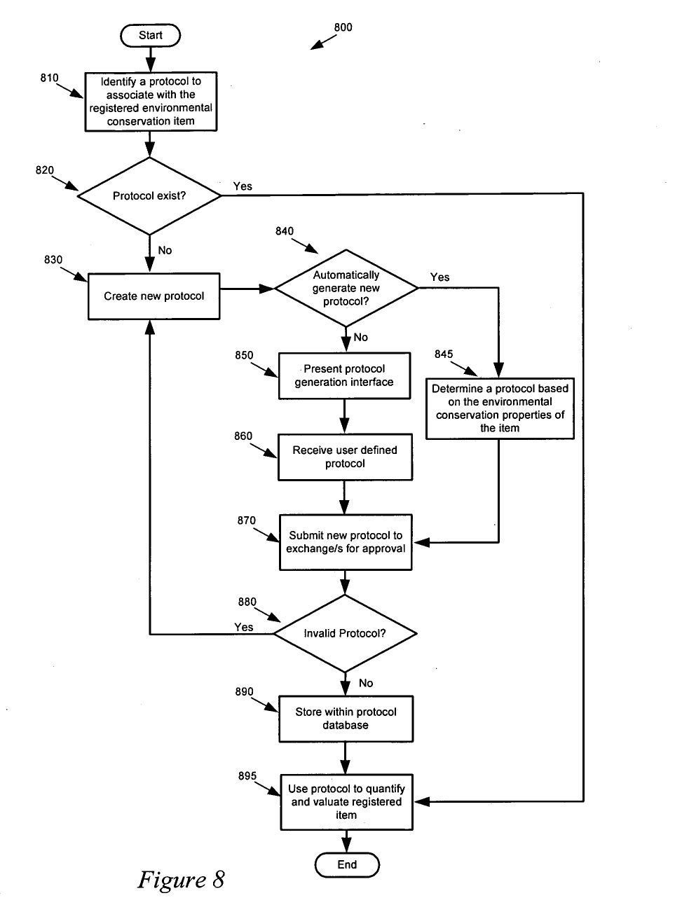

FIG. 8 presents a protocol generation process 800 performed by the protocol generation module of the valuation engine that conceptually illustrates several operations performed by the protocol generation module of the valuation engine to generate a new protocol for an item. The process begins by identifying (at 810) a protocol with which to associate to a newly registered item. If the process identifies (at 820) an existing protocol, that protocol is associated with the item, the process computes (at 895) the environmental conservation value of the item using the identified protocol, and the process ends. If the process cannot identify (at 820) an existing protocol, then the process directs (at 830) the protocol generation module to generate a new protocol.

The process determines (at 840) whether to automatically or manually generate the protocol. If automatic protocol generation is selected (at 840), then the process identifies (at 845) specified environmental conservation properties of the registered item which hold information that assist in determining a formula for computing the environmental conservation value of the item. For instance, registration of a new energy efficient light bulb with properties stating that the light bulb produces the same luminance as a traditional incandescent light bulb but with half of the actual wattage used contains sufficient information to automatically propose a new protocol to quantify the environmental conservation value of the energy efficient light bulb. A more detailed description of the automated protocol generation is presented with reference to subsection ii) below. The process submits (at 870) the automatedly defined protocol for approval with some validating authority. If the protocol is determined to be valid (at 880), the process stores (at 890) the protocol within the protocol database for use with subsequently registered items and the protocol is used (at 895) to quantify and valuate the environmental conservation associated with the currently registered item. If the protocol is invalid (at 880), then the protocol is modified (at 830) and a new protocol is submitted for validation.

If manual protocol generation is selected (at 840), then the process presents (at 850) the protocol generation interface through which a user manually specifies parameters and equations for a protocol. The manual protocol generation interface is described in further detail below with reference to subsection i) below. The process receives (at 860) the user defined protocol and submits (at 870) the defined protocol for approval with some validating authority. Again, if the protocol is validated (at 880), the process stores (at 890) the protocol within the protocol database for use with subsequently registered items and the protocol is used (at 895) to quantify and valuate the environmental conservation associated with the currently registered item. If the protocol is invalid (at 880), then the protocol is modified (at 830) and a new protocol is submitted for validation.

i. Manual Protocol Generation

Some embodiments allow the manual protocol generation to occur at the time when a manufacturer creates a new item or releases the new item into the stream of commerce. At such time, the manufacturer enters identification information pertaining to the manufactured item such as the make and model of the item. The manufacturer can also enumerate the environmental conservation properties of the item. Additionally, the manufacturer can specify a protocol to be used in calculating the environmental conservation value of the item whenever a consumer of the item comes to register the item with some embodiments of the invention.

In some embodiments, the manufacturer modifies existing protocols to conform to the environmental conservation properties of the item. Moreover, in some embodiments, the manufacturer proposes entirely new processes or heuristics for the protocols. Since the manufacturer is typically the entity with the most knowledge regarding the properties and environmental conservation associated with the item, the manufacturer is best suited to propose protocols for its items. However, it should be apparent to one of ordinary skill in the art that some embodiments of the invention permit consumers and other entities the ability to specify custom protocols for use in computing the environmental conservation value of an item.

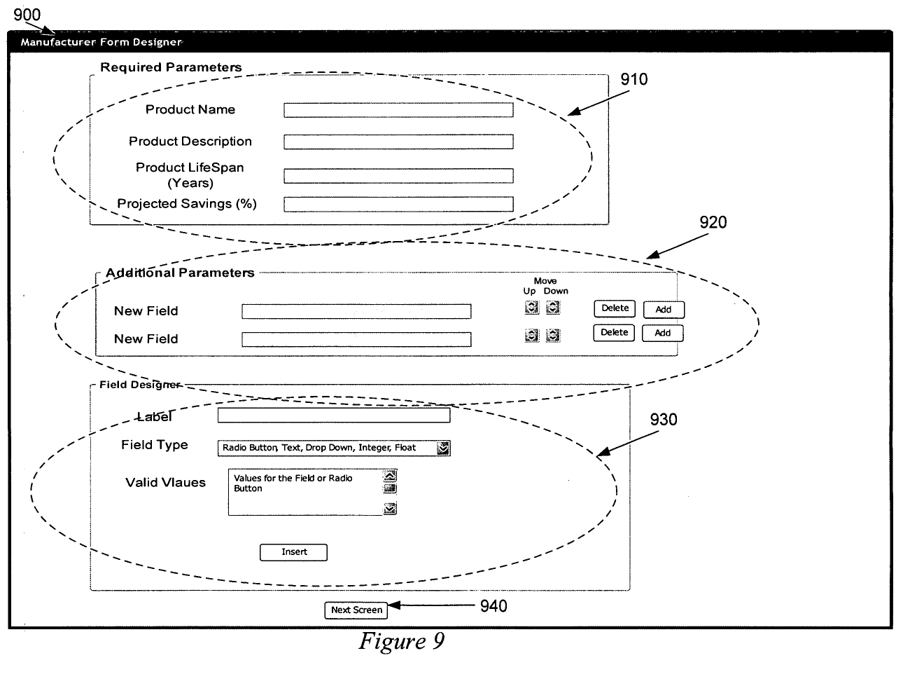

Some embodiments facilitate manual protocol definition by providing a graphical interface through which manufacturers or other entities provide the parameters and baseline metrics necessary for computing an environmental conservation value for an item. FIGS. 9-12 illustrates some such graphical interfaces for the facilitation of manual protocol generation.

First, FIG. 9 illustrates a graphical interface 900 through which manufacturers define and enter certain parameters to uniquely identify each of their environmental conservation items from other environmental conservation items registered within the system. The graphical interface 900 includes a set of required parameters 910 such as a product name, description, lifespan, and projected savings. The graphical interface 900 includes additional parameters 920 that further assist in the identification of the item or that further enumerate the environmental conservation properties of the item such that a subsequent registrant need not enter these properties as they can be automatically populated after the item is uniquely identified. The graphical interface 900 also includes a field designer 930 to create custom fields for the consumer registration of the item.

Each of the various parameters 910 and 920 and fields 930 include editable user interface items such as text boxes, selectable icons for manipulating the interface, drop down boxes to select between different entries, etc. After defining the enumerated parameters 910 and 920, fields 930, and selecting the button 940 to submit the data to the protocol generation module, a set of processes are executed to automate the creation of database tables and the population of the tables with the specified data such that it is stored within a computer readable medium of some embodiments.

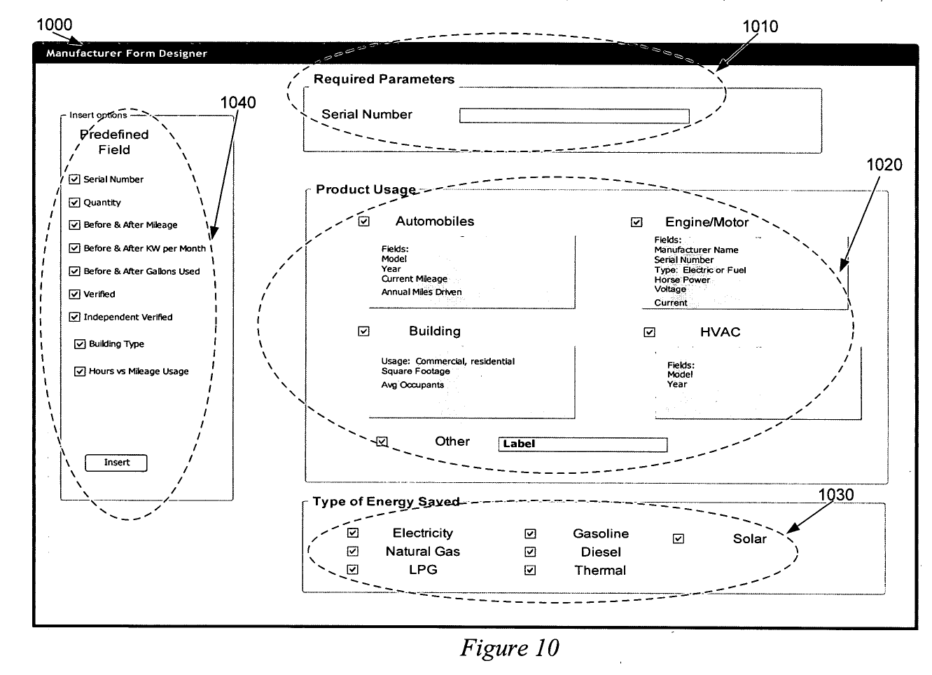

Next, some embodiments create the required logic for screen definitions of the subsequent graphical displays for the specific manufacturer. This is achieved by dynamically storing the screen definitions in an XML format or within a database screen specific schema. FIG. 10 presents a screen definition provided to a manufacturer to further define a registration screen 1000 for subsequent consumers of an item in accordance with some embodiments of the invention.

In FIG. 10, a manufacturer may specify a set of required parameters 1010 to uniquely identify the item to be registered and different item usage parameters 1020 to specify the various environmental conservation properties for the item. The usage parameters 1020 also include parameter for qualifying the use of the item such that the amount of environmental conservation is particular to how a registrant uses the item. For example, vehicle owners have different driving habits such that a first driver of a particular automobile drives less mileage per year than a second driver of the same particular automobile. Accordingly, the first driver will have a smaller carbon footprint than the second driver and it is through the usage parameters 1020 that this information is conveyed to the system. It should be apparent to one of ordinary skill in the art that once the required identification parameters 1010 are specified, some embodiments automatically populate some of the environmental conservation properties for an item. For instance, by entering a VIN number of an automobile, some embodiments are able to populate the year, make, model, engine size, etc. of the automobile. Other fields are customizable by the manufacturer creating the interface 1000. These customized fields enumerate additional data fields 1030 and 1040 to be populated for any particular item.

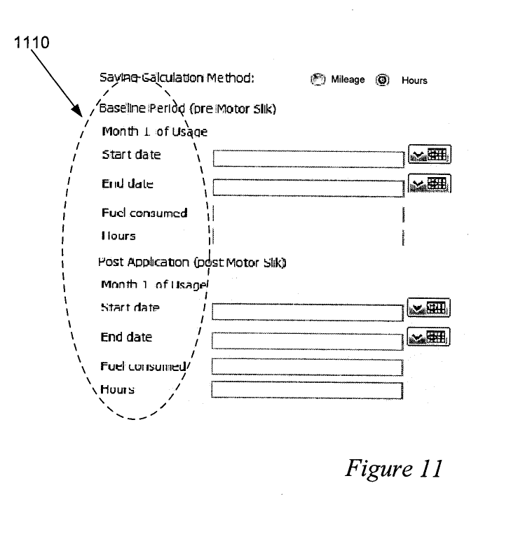

FIG. 11 presents a graphical interface for defining qualification parameters related to the actual use of an item by a registrant. Specifically, FIG. 11 presents a set of pre-defined fields 1110 and screen segments that can be added to the registration interface in order to better define the environmental conservation associated with automobile use. In this figure, the fields 1110 include verified and non-verified parameters for CO2 emission calculation and qualification.

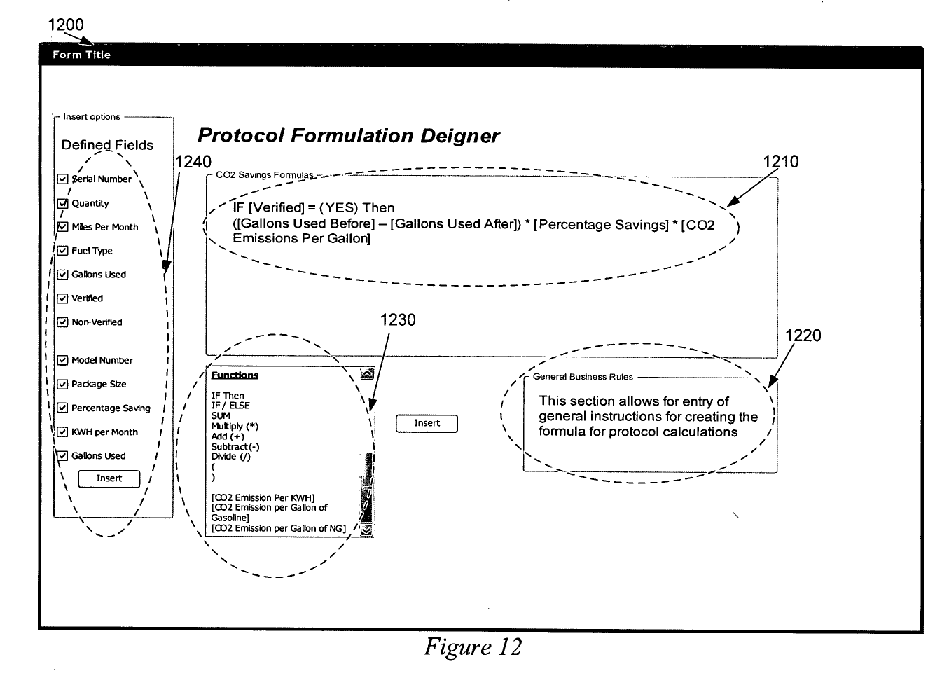

After the identification information, environmental conservation property information, and/or qualification information for an item is specified, some embodiments then permit a manufacturer the ability to specify a protocol to convert such information into quantified amounts of environmental conservation. FIG. 12 presents a protocol definition graphical interface 1200 for manually defining a protocol for a new environmental conservation item. Specifically, the interface 1200 defines the logic for calculating CO2 emissions. As seen in the figure, a formula entry area 1210 permits the user to create custom formulas to quantify the environmental conservation of the item. Additional rules 1220 operate in conjunction with the specified formula. To simplify the formula generation, some embodiments provide a set of usable functions 1230 and different fields 1240 that may be inserted within the formula entry area 1210. In many instances, to quantify an amount of environmental conservation produced by an item, the environmental conservation of the item being registered must be compared to the environmental conservation produced by an analog of the item which is replaced by the item being registered. Though not shown in FIG. 12, some embodiments further permit manufacturers the ability to define fields for specifying the identification information and environmental conservation information related to the replaced item. In some embodiments, manufacturers can provide a listing of such items with their associated properties so that a subsequent consumer registering an item need only select the analog from the list pre-populated by the manufacture.

ii. Automated Protocol Generation

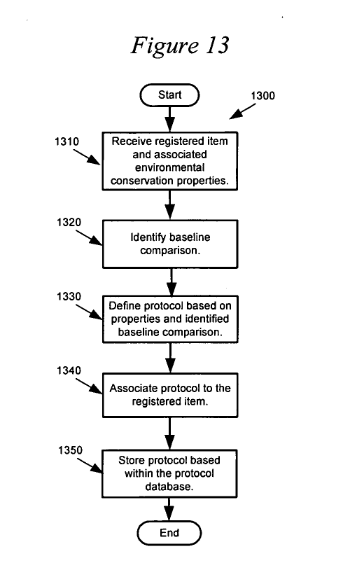

An alternative to the manual protocol generation process described above, some embodiments provide a mechanism for automatically generating a protocol without user action. FIG. 13 presents an automated protocol generation process 1300 performed by the protocol generation module of the valuation engine that conceptually illustrates several operations performed by the protocol generation module to automatically generate a new protocol for an item. The process begins by receiving (at 1310) a set of environmental conservation properties associated with a newly registered item. Some such environmental conservation properties include the energy consumption rate of the item (e.g., wattage of a light bulb), the utility provided by the item (e.g., the luminance of a light bulb), etc.

As most environmental conservation is defined with respect to some previously existing less efficient analog, the process then identifies (at 1320) a baseline to be used in determining the protocol for the item. For instance, when measuring the energy savings of a compact fluorescent light bulb, the luminance per wattage consumption of the compact fluorescent light bulb will be compared to the luminance per wattage consumption of a less efficient, baseline incandescent light bulb. To provide an accurate computation of an actual amount of environmental conservation, some embodiments require a user to identify the baseline item as an item that is replaced by the item being registered. In such instances, the user need only identify the item and the necessary environmental conservation properties of the item are automatically pre-populated for the user. This and other qualification parameters that tie the use of the item to actual consumption parameters are described further below in subsection C).

The process then combines (at 1330) the environmental conservation properties of the item and the baseline metric if one is automatically selected by the process or the list of potential baseline metric if the user must select a particular metric into an equation that computes an environmental conservation value of the registered item. The environmental conservation value numerically represents a quantifiable amount of emissions reductions, energy savings, reductions in hazardous material, or generated renewable energy. For example, with reference to the light bulb example above, the difference in energy consumed between the energy efficient light bulb and the less efficient light bulb results in an amount of emissions that were not released into the atmosphere. Such an amount is then converted into a numeric value that becomes the environmental conservation value of the item.

The process associates (at 1340) the newly generated protocol at 1330 with the item. The process then stores (at 1350) the item within the database where it can later be accessed by the valuation engine to compute the environmental conservation value for subsequently registered items.

While the above illustration presented the automated protocol generation for an energy consuming item, it should be apparent to one of ordinary skill in the art that the process is adaptable to generate protocols for various other types of items. For instance, an automobile lubricant typically will not specify a set of environmental conservation properties that identify the energy savings or emissions reductions associated with the lubricant. However, some embodiments of the process of FIG. 13 nevertheless determine a protocol with which to associate to such an item as the item indirectly may improve the efficiency of the automobile resulting in fewer emissions over the useful life of the vehicle. The improved efficiency therefore has an associated and quantifiable environmental conservation associated therewith.

C. Protocol Validation

Before either the automatically generated or manually generated protocol can be used to compute the environmental conservation value associated with an item, some embodiments of the valuation engine submit the newly defined protocols for approval. Approval in some embodiments occurs with a protocol governing entity such as an “Institute of Protocol Verification” (IPV) provided by some embodiments. The IPV is responsible for overseeing and managing the various proposed protocols. The IPV retains authority over validating or rejecting the proposed protocols in order to ensure that all approved and applied protocols conform to certain de minimis standards.

These standards validate protocols in view of existing government standards, regulations, and criteria used by other recognized exchanges. For instance, the Chicago Climate Exchange (CCX) contains a set of proprietary protocols. Therefore, in order to issue credits tradable within the CCX, the protocols used in issuing credits should similarly be approved by the CCX or through a manner accepted by the CCX. Therefore, the IPV of some embodiments validates protocols in tandem with, but with no authority over other exchanges, such as the CCX. However, in some embodiments, the IPV is an entity that provides protocol validation for all environmental commodity exchange systems.

To validate the newly generated protocols, some embodiments submit a request to the IPV specifying the protocol and item at issue. If the item is an environmental conservation project, the IPV will send one or more inspectors to the project site to inspect that the defined protocol for quantifying the environmental conservation resulting from the project is trustworthy and an accurate representation of the environmental conservation resulting from the actual project. In other embodiments, the item at issue can be issued by submitting a sample of the item to the IPV. The IPV inspects the item to ensure compliance with the defined protocol used to quantify the environmental conservation produced by the item.

As noted above, protocol validation is necessary as the protocols used in valuing the registered environmental conservation items are effective only so far as they are recognized and approved by a pool of potential buyers and sellers. For instance, protocols certified to comply with government regulations or standards set forth by various regulatory bodies contain an inherent value by virtue of the fact that such protocols can be used to issue tradable credits that meet the government or regulatory bodies' standards for environmental conservation. Therefore, any credits issued using such protocols can be used to offset the environmental polluting activities of the buyer, to provide verification of environmentally friendly practices, or other forms of conservation. The purchased credits assist the buyer in conforming to governmental mandates and regulations which otherwise could subject the buyer to fines or the possibility of costly litigation in verifying that the buyer's activities were in line with the mandates and regulations.

Moreover, some embodiments increase the potential set of buyers and sellers by permitting the issuance of environmental conservation credits based on protocols approved by entities other than government or other environmental regulatory bodies. For instance, a conglomerate of manufacturers may voluntarily band together forming a set of standards to govern their own business practices. Such standards need not comply with existing governmental or regulatory mandates or such standards may be defined more stringently than those of the governmental or regulatory mandates.

Sellers voluntarily join into the conglomerate offering their environmental conservation items as a tradable commodity to other environmental polluting entities that have agreed to abide by such an accord. The polluters would agree to purchase credits to offset their polluting activities from the sellers. For instance, in order to establish goodwill or an environmentally friendly reputation, some entities voluntarily commit to purchasing credits representing renewable or green forms of energy though no regulatory statute requires these entities to do so. Additionally, some protocols may necessitate approval by multiple entities. Multiple approval of the same protocol may be necessary in instances where different jurisdictions issue independent sets of standards from which to approve protocols. For instance, some embodiments validate protocols at both a state and municipal level such that any registered environmental conservation using these protocols will be recognized at both the state and municipal level.

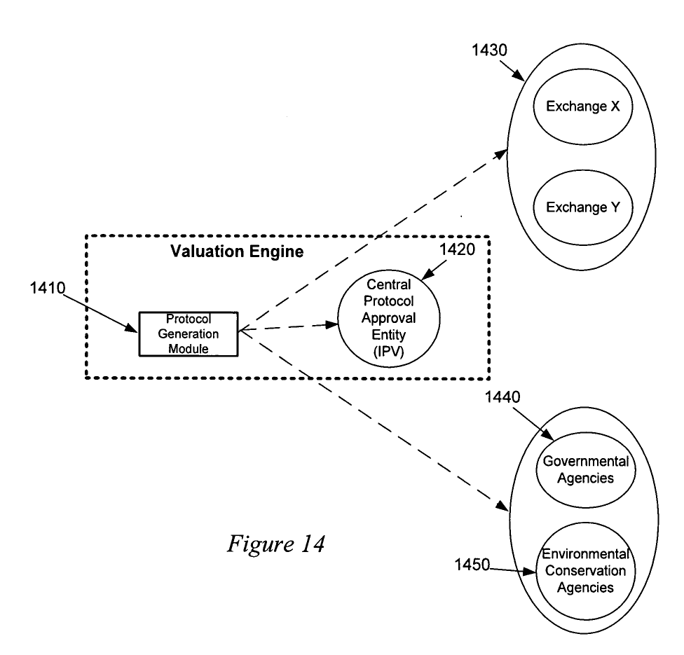

FIG. 14, provides a computer implemented and automated method for submitting newly generated protocols to a protocol approving entity in accordance with some embodiments. In FIG. 14, the protocol approving entity includes one or more protocol approving entities. In some embodiments, the protocol generation module 1410 submits a proposed or newly generated protocol to a central protocol approving entity 1420 which in some embodiments includes the IPV. Other protocol approving entities include other recognized exchanges 1430 with proprietary sets of protocols, various governmental agencies 1440, or other environmental conservation agencies 1450.

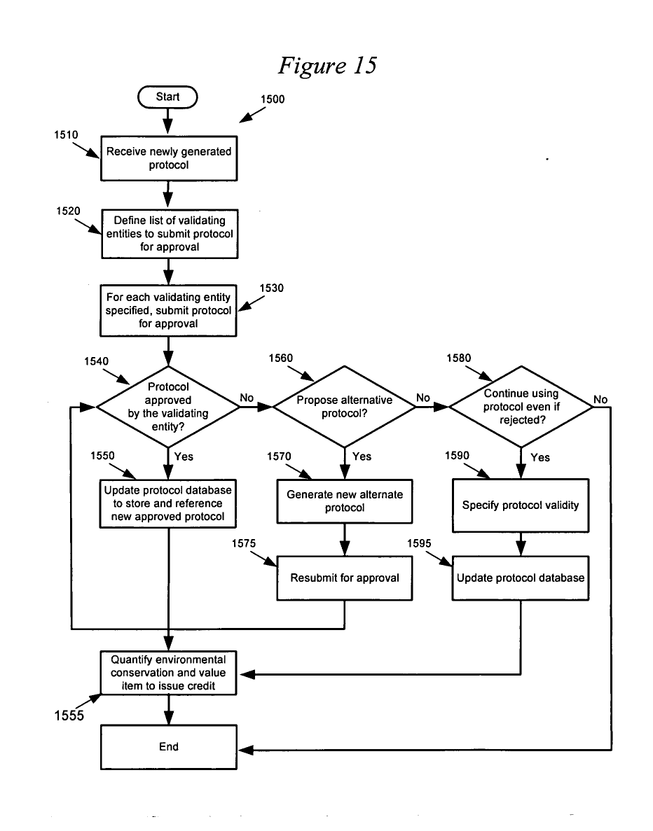

The automated protocol submission and approval process of FIG. 14 may be conducted with some or all such entities. FIG. 15 presents a process 1500 that conceptually illustrates several operations performed for facilitating the automated submission of protocols for validation. The process begins by receiving (at 1510) a yet to be validated protocol. As discussed above, validation may occur with one or more different validating entities. Therefore, the process enumerates (at 1520) a list of validating entities. In some embodiments, such a list is automatically created by the system based on some predetermined criteria. Other embodiments optionally permit the user to define the list of validating entities for which to submit the protocol for approval.

With the list of validating entities enumerated, the process submits (at 1530) via an electronic or computer implemented interface, the protocol for approval to each validating entity. In some embodiments, communication over the computer implemented interface requires a set of secure communication protocols and/or accounts by which to access such validating entities. However, rather than submit the protocols using the registrant's identification information, some embodiments of the invention utilize a single identification parameter for interfacing with such validating entities. In this manner, protocol submission occurs on behalf of the registrant and the validating entity never discovers the identity of the actual registrant.

After submission of the protocol to the validating entity, the protocol database in some embodiments is updated to reflect the pending status of the protocol. The protocol is therefore marked and will not be used in quantifying and valuating environmental conservation items until the protocol is approved by some validating entity. However, some embodiments permit the protocol to be used for internally issued credits bought, sold, and traded on an internal platform. The protocol will be updated again once the process receives (at 1540) a response from the validating entity.

If the protocol is approved by the validating entity, the process updates the protocol database to store (at 1550) and reference the newly approved protocol. Moreover, the process can then use the protocol to value (at 1555) any registered items associated with the protocol. These registered items include any items awaiting valuation at the time the protocol was submitted for approval and also include future items yet to be registered within the system. Once valued, a tradable credit is issued and the registrant is compensated for his contribution to the credit.

However, should the submitted protocol be rejected by the validating entity at 1540, the process provides (at 1560) a failsafe or alternate procedure for protocol validation. The alternate procedure provides for the automatic generation (at 1570) and submission (at 1575) of a modified protocol for validation. In this manner, some embodiments propose a more conservative alternate protocol that better conforms to regulatory mandates. Such a validation procedure can continually occur until a protocol is approved, though a further failsafe approach is provided for at 1580.

At 1580, a protocol that has been rejected by one or more validating entities can nevertheless be used in valuating and issuing tradable credits within the trading platform of some embodiments of the invention. In this manner, the tradability of the credit is limited as only the trading platform provided in some embodiments recognizes the protocol used in valuating the credit. Other exchanges may not have approved the protocol and therefore the credit has no value to these exchanges.

Even so, some registrants may choose to go ahead with the use of the protocol. For example, a seller already in agreement with a buyer as to a set of rules governing their environmental conservation activities with respect to one another would not need a protocol approved by a governmental body or any other agency. Therefore, some embodiments of the invention permit these parties to proceed with using the protocol to issue credits, though such credits may not be tradable with the majority of registrants.

The process marks (at 1590) all protocols to specify their validity and updates (at 1595) the protocol database to reflect the valid scope of the protocol. In this way, buyers accessing the trading platform seeking only certain approved credits are able to filter out credits issued pursuant to protocols approved by other bodies or unapproved protocols. The invalidated protocol may then be used to issue (at 1555) tradable credits.

D. Qualification

To accurately determine the environmental conservation produced by an item, some embodiments qualify the item and the associated protocol prior to quantifying the environmental conservation associated with the item. Qualification provides the more accurate environmental conservation determination by accounting for factors other than just the properties of the item. Qualification involves ascertaining parameters related to the actual use and application of the item such that the environmental conservation computed for each item is unique by virtue of the fact that the calculation is dependent on how the registrant uses the item.

Prior art methods of determining the environmental conservation produced by an item omit the qualification step. Instead, these prior art methods determine the environmental conservation based on estimated averages on how the item is expected to be used. For example, vehicles are sold with government approved C.A.F.E. ratings that specify city and highway mileage per gallon for a vehicle. The prior art methods uniformly apply the C.A.F.E. ratings for each particular vehicle irrespective of how the vehicle is actually driven. Therefore, a driver continually experiencing heavy traffic conditions would receive the same environmental conservation as a driver in a less congested area who continually averages an optimal speed for optimal fuel consumption (i.e., 55 mph).

To provide the more accurate environmental conservation value, some embodiments utilize the qualification parameters to include other factors within the environmental conservation determination. For computing the environmental conservation associated with a hybrid vehicle, these factors include road conditions (e.g., traffic conditions and speed limits), individual driving habits (e.g., heavy acceleration), and average temperature where a particular vehicle that intakes colder air receives better gas mileage than the same vehicles that intakes warmer air.

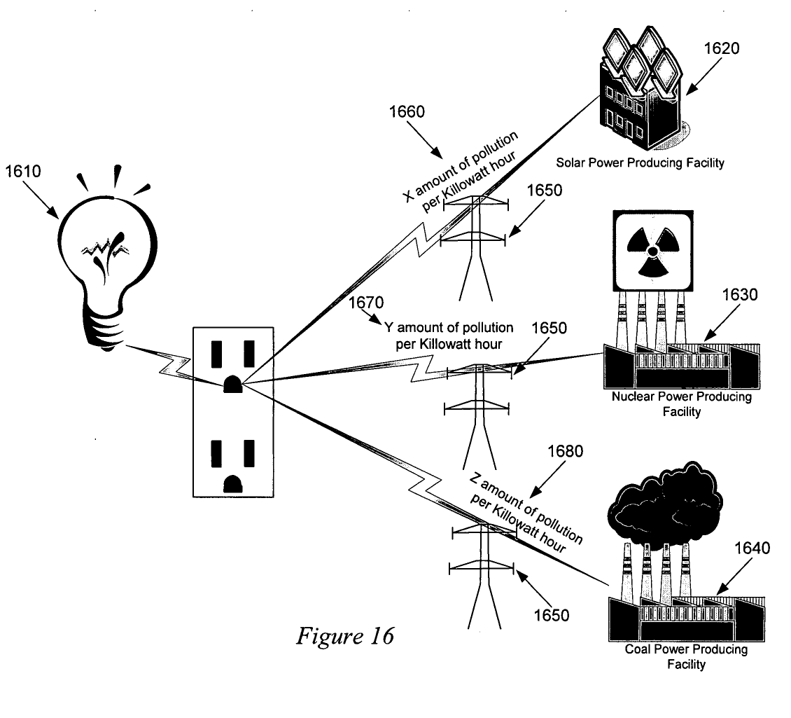

FIG. 16 presents various qualification parameters associated with the electrical usage of an environmental conservation item. In this figure, the qualification parameters include factors such as the manner in which the power producing facility generates the electricity that is consumed by the item and the distance of the item from the power producing facility such that providing electricity to an item that is further away results in greater line loss.

The figure illustrates three possible power producing facilities 1620, 1630, and 1640 that provide the necessary electricity for an energy efficient light bulb 1610. The same item 1610 located in different locales will receive power from different power producing facilities 1620, 1630, and 1640.

The power producing facilities include: a solar power producing facility 1620 that creates a first amount of pollution per kilowatt hour produced 1660, a nuclear power producing facility 1630 that creates a second amount of pollution per kilowatt hour produced 1670, and a coal power producing facility 1640 that creates a third amount of pollution per kilowatt hour produced 1680. The pollution produced by each plant may include one or more different forms of pollution such as the CO2 footprint, sulfur dioxide (SOX) footprint, nitrogen oxide (NOX) footprint, and other greenhouse gas footprints of the facility. In this manner, the environmental conservation associated with the item can be quantified over multiple different dimensions, each such dimension quantifying to create a different environmental conservation value or an aggregate value that includes all such dimensions.

By qualifying the energy source, some embodiments directly compute the energy conservation associated with the energy efficient light bulb 1610 by accounting for the actual pollution 1660, 1670, and 1680 associated with the energy consumed by the bulb 1610. Additionally, some embodiments qualify the line loss 1650 associated with the transmission of the electricity from the power producing facility to the outlet providing power for the bulb 1610. The further the distance of the outlet from the power producing facility, the greater the resulting line loss. The greater line loss results in more electricity having to be produced and thus more pollution being emitted in order to power the same item simply by virtue of the fact that the item is located a greater distance from the power producing facility. It should be apparent to one of ordinary skill in the art that some embodiments account for any such number of qualification parameters when quantifying the environmental conservation associated with an item.

In some embodiments, qualification involves receiving from the user a less environmentally friendly item that is being replaced by the more efficient item being registered. Some embodiments then compute the amount of environmental conservation resulting from the more efficient item by determining the difference in emissions produced or energy consumed between the two items. In this manner, the amount of computed environmental conservation is particular to the user. Specifically, the amount of computed environmental conservation is particular to the direct environmental gains resulting from the replacement of an older less efficient item. Therefore, a user purchasing an energy efficient light bulb to replace another energy efficient light bulb will result in little to no environmental conservation whereas the same user purchasing the energy efficient light bulb to replace a less efficient incandescent bulb will result in greater environmental conservation.

In some embodiments, qualification also includes verifying that a particular environmental conservation stated by a registrant or manufacturer of the item performs as stated. This involves certifying the environmental conservation properties of the item and also the protocol that will be used to quantify the environmental savings associated with the item. Therefore, a manufacturer of a device claiming that a device (e.g., an automobile turbo) improves a vehicle's mileage per gallon by 20% will be required to submit documentation to verify such claims. The documentation may include reproducible test reports, independent laboratory results, or studies that validate the manner in which the fuel savings is provided by the device. The data is provided electronically through a graphical interface provided by some embodiments. Once validation of the data is complete through an automated process of some embodiments, the data is subsequently used as qualification parameters to further enhance the accuracy of the computed environmental conservation resulting from the use or application of the environmental conservation item.

To perform qualification, some embodiments store the various qualification parameters within a qualification database. In some such embodiments, a lookup into the database using simple identification information reveals the pertinent information. For example, by storing a nationwide database of power producing facilities and the zipcodes that they service, some embodiments are able to provide the qualification illustrated in FIG. 16. The zipcode data associated with the registered item can also be used to determine the amount of line loss since the distance between the electrical outlet and the power producing facility providing electricity to the outlet can be determined. Similarly, by storing traffic conditions for highways and associated zipcode, some embodiments qualify fuel consumption by incorporating the traffic condition factors when computing the environmental conservation associated with hybrid, pure electrical, or fuel efficient vehicles.

E. Quantification

Some embodiments quantify the environmental conservation associated with an item by applying the environmental conservation properties of the item and the associated qualification parameters to an identified protocol that converts such properties and parameters into an environmental conservation value. The environmental conservation value is a numeric representation for an amount of reduced emissions, energy savings, properly disposed of hazardous waste, or generated renewable energy associated with the item. Such a value may represent the actual amount of conservation, such as a reduction of ½ ton of CO2, or the value may represent a scaled score that represents a portion of a tradable credit that will issue from the environmental conservation associated with the item. For instance, in some embodiments, the environmental conservation value is a score between [0 . . . 1] where a value of 1 represents that the environmental conservation associated with the item is sufficient to issue a full credit and any value less than 1 represents a fractional portion of a credit. It should be apparent to one of ordinary skill in the art that an item may result in an environmental conservation value greater than 1 if the amount of environmental conservation associated with the item is sufficient to issue multiple credits.

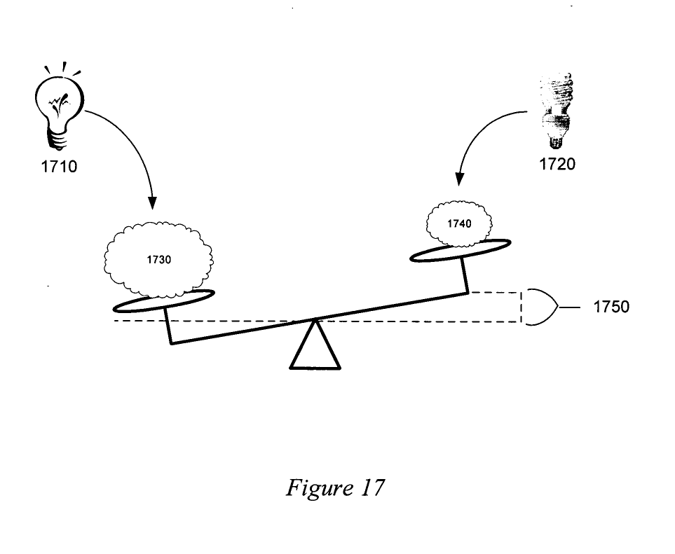

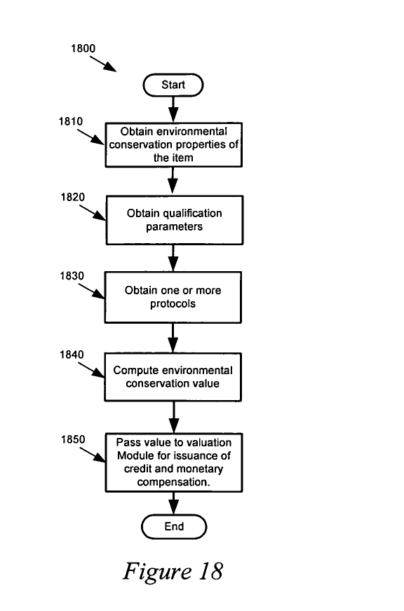

FIG. 17 conceptually illustrates a simplified method of some embodiments for computing an environmental conservation value of an environmental conservation item when considering qualification parameters. FIG. 18 provides a more detailed process for performing the quantification by accounting for the qualification parameters.

In FIG. 17, a protocol for computing the environmental conservation value associated with an energy efficient compact fluorescent light bulb 1720 performs the computation with reference to a traditional incandescent light bulb 1710 that is replaced in a consumer home by bulb 1720. The compact fluorescent bulb 1720 produces the same luminance as the incandescent bulb 1710, but does so using less energy. As noted above, every unit of energy consumed has an associated amount of pollution associated with its consumption. For instance, to generate X watts of electricity, requires a power plant to burn Y amount of coal. The burning of the Y amount of coal releases Z amount of carbon emissions into the atmosphere. Therefore, a reduction in the amount of energy consumed results in some amount of reduction in pollution (e.g., carbon emissions). As noted above, part of the qualification process requires some embodiments to identify the particular power plant that generates the electricity consumed by the light bulbs 1710 and 1720. Identification of the particular power plant further includes identifying the pollution created by the power plant in producing the electricity.

Usage of the compact fluorescent bulb 1720 results in some amount 1740 of carbon emissions while usage of the incandescent bulb 1710 results in some larger amount 1730 of carbon emissions. In some embodiments, the difference in resulting emissions 1750 is the environmental conservation value. However, it should be apparent to one of ordinary skill in the art that some protocols compute the environmental conservation value without using a pre-existing analog (e.g., a government specified standard) or may compute the environmental conservation value using some computed average of various analogs.

FIG. 18 presents a process 1800 performed by the quantification module of the valuation engine for quantifying the environmental conservation associated with an item in order to produce an environmental conservation value for the item. The process 1800 begins by obtaining (at 1810) the environmental conservation properties that were stored at the time the item was registered with the system. For an energy efficient light bulb, these properties may include properties such as the luminance per watt produced by the bulb. The process then obtains (at 1820) the qualification parameters for the item. As noted above, the qualification parameters pertain to parameters for the actual use of the item by the registrant such as identifying the power producing facility that provides the electricity for the item and the different pollution dimensions (e.g., CO2, SOX, NOX, etc.) associated with that facility. Since each facility may include multiple different pollution producing parameters, some embodiments compute several environmental conservation values for a single item, each score quantifying the environmental conservation over a particular dimension of the facility. Alternatively, some embodiments compute a single composite environmental conservation value that accounts for some or all dimensions simultaneously. To compute the one or more environmental conservation values, the process obtains (at 1830) one or more protocols that provide the formulas and heuristics for quantifying the environmental conservation of the item.

An environmental conservation value is computed (at 1840) from the combination of the obtained properties, parameters, and protocol to quantify the environmental conservation of the item. By accounting for the qualification parameters during quantification, some embodiments produce an environmental conservation value that more accurately defines the environmental conservation associated with the registered item than other prior art methods for environmental conservation quantification. For example, the computed environmental conservation value for a first registrant registering a particular hybrid vehicle with qualification parameters specify that the first registrant commutes nearly 40,000 miles per year and is regularly subject to poor traffic conditions will differ from a second registrant registering the same particular hybrid vehicle but whose qualification parameters specify that the second registrant only commutes 10,000 miles per year and rarely experience heavy traffic. Accordingly, the environmental conservation value computed for the first registrant should represent the larger carbon footprint of the first registrant when compared to the second registrant. The environmental conservation value subsequently passes (at 1850) to the valuation module of the valuation engine where credits are issued, the registrant is provided monetary compensation based on the environmental conservation value, and the process ends.

F. Valuation

In some embodiments, the environmental conservation value is converted into a monetary value by issuing a tradable credit or portion of a tradable credit based on the quantified amount of environmental conservation. The intrinsic value of environmental credits lie in the fact that the credits are usable for offsetting pollution producing activities to ensure that the registrant is in compliance with one or more pollution restricting regulations (e.g., Kyoto protocol). Therefore, determining the monetary value from the environmental conservation value is a function of what the monetary value for a credit with similar environmental conservation values has at the time of sale based on market conditions. In a market where the supply of credits is scarce, it is likely that the monetary value will be higher due to the higher demand than in a market where supply is in surplus. Additionally, some embodiments consider internationally agreed treaties, international and national standards, or voluntary pacts among two or more entities in computing the monetary value.

Moreover, some embodiments of the invention determine the monetary value based on a set of utility issued rebates. Such rebates are issued by various environmental conservation agencies. The rebates of some embodiments provide a uniform system by which recycled items may be redeemed for a monetary value. For instance, when an item containing hazardous materials is properly disposed of, the disposal site issues a rebate to be redeemed by the disposing party. The disposing party then registers the rebate with some embodiments of the invention. The amount of the rebate is determined and a monetary value is distributed to the registrant.

To perform the valuation, some embodiments determine from the quantified environmental conservation value how many credits or portions of a credit may be issued from the registered environmental conservation. For a standardized credit that represents 1 ton worth of CO2 emissions, an environmental conservation value that represents only a quarter of the 1 ton worth of emissions will receive only a quarter of the market value for such a credit. Therefore, if such a credit has a real-world market value of $20 within the environmental commodities exchange, then a newly registered item with an environmental conservation value of ¼ ton of CO2 emission would at most receive a monetary value of $5. However, it should be apparent to one of ordinary skill in the art that in some embodiments, the monetary value provided to registrants is reduced to account for commissions or overhead costs in providing the valuation service. In this manner, the registrant may immediately be compensated for his/her registered environmental conservation value, irrespective of whether the environmental conservation value from the item has been used to issue a credit that is sold on an exchange.

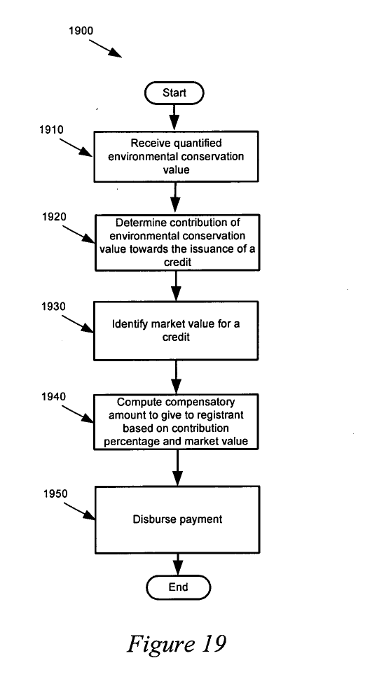

FIG. 19 presents a process 1900 performed by the valuation module of the valuation engine for performing the valuation of a quantified environmental conservation value in order to issue credits and to provide compensation for the contribution towards the issuance of the credits. The process 1900 begins by receiving (at 1910) the quantified environmental conservation value. The process then determines (at 1920) the contribution of the environmental conservation value towards the issuance of a credit. Since some embodiments permit the issuance of credits through the bundling of multiple fractional contributions, it is irrelevant what the total aggregated environmental conservation value from a particular registrant is. In this manner, some embodiments encourage the participation of individuals into the environmental commodities exchange irrespective of the quality or quantity of their contributions. As a result, some embodiments create an incentive to purchase various environmental conservation items by providing such purchasers a direct monetary benefit for the environmental conservation associated with the item.

To compute the monetary worth of the contribution, the process identifies (at 1930) the market value for a credit. The process then computes (at 1940) the compensatory amount to provide to the registrant based on the contribution percentage of the registrant's environmental conservation value to the overall issuance of the credit and the market value of the credit.

The registrant receives (at 1950) the compensable sum based on user preferences and the process ends. The preferences of some embodiments include receiving a check in the mail, donation to other registrants, or a donation to a charity of the registrant's choosing. In some embodiments, registrants are directly compensated for their contributions via a check. However, because the contributions of certain items are only small fractional components of an overall credit, some embodiments instead issue rebate points to the registrants. In some such embodiments, the rebate points represent a compensable value that are redeemable once a certain amount of rebate points are achieved through numerous registrations. Registrants may elect to donate their rebate points to charities or other entities within the system. In yet other embodiments, rather than receive monetary compensation or rebate points, registrants receive direct ownership to a portion of a credit that they can later sell within a trading platform at prevailing market rates.

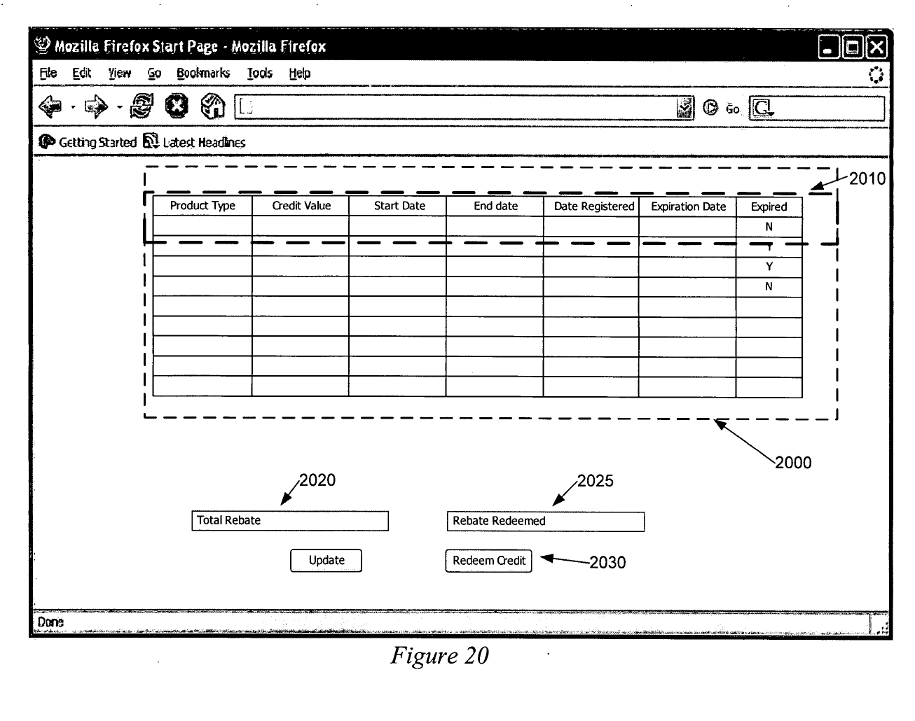

In some embodiments, the value of each registered item can be accumulated and aggregated within the system until a desired disbursement by the registrant is reached. FIG. 20 presents an illustrative interface of some embodiments whereby a balance of all items registered by a particular registrant is tracked. In FIG. 20, items previously registered by the registrant are displayed within a table 2000 of the computer implemented interface. The table 2000 includes various fields 2010 for identifying properties of the previously registered items. A total redeemable value for all the registered entries is displayed in the field 2020. A second field 2025 displays the value of the amount from the total redeemable value 2020 that has yet to be redeemed by the registrant.

Whenever a registrant registers a new item, deactivates a previously registered item, or redeems the value for a previously registered item, the table 2000 and the total redeemable value 2020 will be updated. The registrant then has the option to receive the yet to be redeemed value by selecting the link 2030. Once selected, the system disburses payment according to the user preferences.

In some embodiments the redeemable value is fixed at the time of item registration. However, alternative embodiments continually track the value of registered but unredeemed items and only fix the value when the registrant decides to redeem the value. In this manner, the registrant may time disbursement with favorable market conditions and therefore achieve a higher return on a registered item.

V. Computer System

Many of the above-described engines, modules, and processes are implemented as software processes that are specified as a set of instructions recorded on a machine readable medium (also referred to as computer readable medium). When these instructions are executed by one or more computational element(s) (such as processors or other computational elements like ASICs and FPGAs), they cause the computational element(s) to perform the actions indicated in the instructions. Computer is meant in its broadest sense, and can include any electronic device with a processor. Examples of computer readable media include, but are not limited to, CD-ROMs, flash drives, RAM chips, hard drives, EPROMs, etc.

In this specification, the term “software” is meant in its broadest sense. It can include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention.

In some embodiments, the various engines and modules described herein represent physical hardware devices that implement the functionality associated with each of the enumerated engines, modules, and processes. It should therefore be apparent to one of ordinary skill in the art that some such engines, modules, or processes are conceptually illustrated as automated machine processes executed without user interaction. However, in some embodiments, some such engines, modules, or processes may be different technical implementations such that they are implemented using a combination of automated and manual processes.

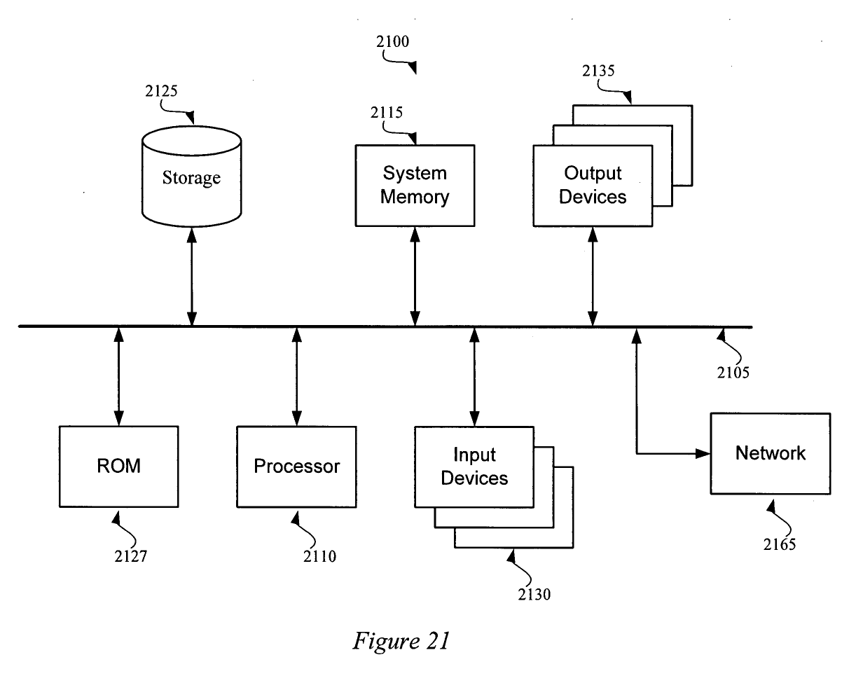

FIG. 21 conceptually illustrates a computer system 2100 with which some embodiments of the invention are implemented. Specifically, the computer system 2100 is for executing the various processes described herein or for illustrating the various modules that comprise the hardware devices used to implement the functionality described herein.

The computer system 2100 includes a bus 2105, a processor 2110, a system memory 2115, a read-only memory 2120, a permanent storage device 2125, input devices 2130, and output devices 2135. The bus 2105 collectively represents all system, peripheral, and chipset buses that support communication among internal devices of the computer system 2100. For instance, the bus 2105 communicatively connects the processor 2110 with the read-only memory 2120, the system memory 2115, and the permanent storage device 2125.

From these various memory units, the processor 2110 retrieves instructions to execute and data to process in order to execute the processes of the invention. In some embodiments the processor comprises a Field Programmable Gate Array (FPGA), an ASIC, or various other electronic modules for executing instructions. The read-only-memory (ROM) 2120 stores static data and instructions that are needed by the processor 2110 and other modules of the computer system. The permanent storage device 2125, on the other hand, is a read-and-write memory device. This device is a non-volatile memory unit that stores instruction and data even when the computer system 2100 is off. Some embodiments of the invention use a mass-storage device (such as a magnetic or optical disk and its corresponding disk drive) as the permanent storage device 2125. Some embodiments use one or more removable storage devices (flash memory card or memory stick) as the permanent storage device.

Like the permanent storage device 2125, the system memory 2115 is a read-and-write memory device. However, unlike storage device 2125, the system memory is a volatile read-and-write memory, such as a random access memory. The system memory stores some of the instructions and data that the processor needs at runtime.

Instructions and/or data needed to perform processes of some embodiments are stored in the system memory 2115, the permanent storage device 2125, the read-only memory 2120, or any combination of the three. For example, the various memory units contain instructions for processing multimedia items in accordance with some embodiments. From these various memory units, the processor 2110 retrieves instructions to execute and data to process in order to execute the processes of some embodiments.

The bus 2105 also connects to the input and output devices 2130 and 2135. The input devices enable the user to communicate information and select commands to the computer system. The input devices 2130 include alphanumeric keyboards and cursor-controllers. The output devices 2135 display images generated by the computer system. The output devices include printers and display devices, such as cathode ray tubes (CRT) or liquid crystal displays (LCD). Such displays can be used to view the multi-server control panel of some embodiments of the invention. Finally, as shown in FIG. 21, bus 2105 also couples computer 2100 to a network 2165 through a network adapter (not shown). In this manner, the computer can be a part of a network of computers (such as a local area network (“LAN”), a wide area network (“WAN”), or an Intranet) or a network of networks (such as the Internet).

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated.

We claim:

1. A method comprising:
a) receiving a plurality of environmental conservation items comprising a plurality of environmental conservation properties;
b) for each particular item, identifying a protocol from a plurality of protocols for quantifying an amount of environmental conservation associated with the particular item based on at least one property of the item; and
c) computing the amount of the environmental conservation associated with each particular item using the identified protocol.

2. The method of claim 1, wherein the at least one property for identifying the protocol comprises an identifier that uniquely identifies said item from other items in the plurality of items.

3. The method of claim 2, wherein the unique identifier comprises at least one of a universal product code (UPC), stock keeping unit (SKU), serial number, or vehicle identification number (VIN) associated with the item.

4. The method of claim 1 further comprising valuating the computed amount of environmental conservation in order to monetarily compensate a registrant of the item for the environmental conservation associated with the item.

5. The method of claim 1 further comprising issuing a tradable commodity comprising the computed amount of environmental conservation of at least one item, said commodity for trading within an environmental commodities exchange platform.

6. The method of claim 1, wherein computing the amount of the environmental conservation comprises quantifying an amount of environmental conservation associated with the item relative to an analog equivalent of said item that provides less environmental conservation.

7. The method of claim 1, wherein the plurality of protocols comprises at least two protocols for quantifying the amount of environmental conservation associated with a single item according to requirements of two different jurisdictions.

8. The method of claim 1 further comprising receiving the plurality of protocols from a plurality of environmental conservation item manufacturers, each manufacturer defining protocols to quantify the environmental conservation associated with their manufactured items, wherein identifying the protocol comprises identifying a protocol from the plurality of manufacturer defined protocols.

9. A method comprising:
a) providing an interface for specifying environmental conservation properties for a plurality of environmental conservation items; and
b) providing a valuation engine (i) for automatically selecting a protocol from a plurality of protocols to determine an amount of environmental conservation associated with an item based on at least one property of the item, and (ii) for quantifying the amount of environmental conservation associated with the item using the selected protocol.

10. The method of claim 9 further comprising monetarily compensating a registrant of an item relative to the quantified amount of environmental conservation.

11. The method of claim 9 further comprising issuing a tradable environmental commodity comprising the quantified amount of environmental conservation associated with the item in order to offset polluting activities of a buyer of said commodity.

12. The method of claim 9, wherein the quantified amount of environmental conservation comprises a reduced amount of emitted carbon emissions resulting from a use or application of said item relative to an analog of said item that is replaced by said item.

13. The method of claim 9, wherein the amount of environmental conservation comprises an amount of energy savings resulting from a use or application of said item relative to an analog of said item that is replaced by said item.

14. The method of claim 9, wherein the amount of environmental conservation comprises an amount of properly disposed of hazardous waste or materials contained by said item.

15. The method of claim 9, wherein the amount of environmental conservation comprises an amount of renewable energy generated from a use or application of said item.

16. The method of claim 9 further comprising automatedly generating a protocol to quantify the environmental conservation associated with the item when a protocol to quantify the environmental conservation associated with the item does not exist within the plurality of protocols.

17. The method of claim 9, wherein at least one protocol is useful for quantifying environmental conservation associated with at least two different items.

18. The method of claim 9, wherein at least two different protocols are useful for quantifying environmental conservation associated with a single item such that environmental conservation for said item is defined according to at least two different regulatory requirements.

19. A computer readable medium storing a computer program for execution by at least one processor, said computer program comprising sets of instructions for:
a) receiving a plurality of environmental conservation items comprising a plurality of environmental conservation properties;
b) for each particular item, identifying a protocol from a plurality of protocols for quantifying an amount of environmental conservation associated with the particular item based on at least one property of the item; and
c) computing the amount of the environmental conservation associated with each particular item using the identified protocol.
